(19) United States
(12) Patent Application Publication
(10) Pub. No.: US 2026/0129243 A1
(43) Pub. Date: May 7, 2026

(54) NEURAL-NETWORK POST-FILTER ON VALUE RANGES AND CODING METHODS OF SYNTAX ELEMENTS

(71) Applicant: Bytedance Inc., Los Angeles, CA (US)

(72) Inventors: Ye-Kui WANG, San Diego, CA (US); Wei JIA, San Diego, CA (US); Jizheng XU, San Diego, CA (US); Kai ZHANG, San Diego, CA (US); Li ZHANG, San Diego, CA (US)

(21) Appl. No.: 19/439,969

(22) Filed: Jan. 5, 2026

Related U.S. Application Data
(63) Continuation of application No. PCT/US2024/036940, filed on Jul. 5, 2024.
(60) Provisional application No. 63/512,346, filed on Jul. 7, 2023.

(51) Int. Cl. H04N 19/80; H04N 19/70; H04N 19/85

(52) U.S. Cl. CPC H04N 19/80; H04N 19/70; H04N 19/85

(57) ABSTRACT

A mechanism for processing video data is disclosed. The mechanism includes determining that a value of a neural-network post-filter characteristics (NNPFC) input format indicator (nnpfc_inp_format_inc) is coded as a u(N) coded syntax element where N is an integer greater than 0. A conversion is performed between a visual media data and a bitstream based on the NNPFC input format indicator.

### CROSS-REFERENCE TO RELATED APPLICATIONS

This is a continuation of International Patent Application No. PCT/US2024/036940 filed on Jul. 5, 2024, which claims the benefit of U.S. Provisional Patent Application No. 63/512,346 filed Jul. 7, 2023, which is hereby incorporated by reference.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing media data, comprising: determining that a value of a neural-network post-filter characteristics (NNPFC) input format indicator (nnpfc_inp_format_inc) is coded as a u(N) coded syntax element where N is an integer greater than 0; and performing a conversion between a visual media data and a bitstream based on the NNPFC input format indicator.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining that a value of a neural-network post-filter characteristics (NNPFC) input format indicator (nnpfc_inp_format_inc) is coded as a u(N) coded syntax element where N is an integer greater than 0; and generating the bitstream based on the NNPFC input format indicator.

A fifth aspect relates to a method for storing bitstream of a video, comprising: determining that a value of a neural-network post-filter characteristics (NNPFC) input format indicator (nnpfc_inp_format_inc) is coded as a u(N) coded syntax element where N is an integer greater than 0; generating the bitstream based on the NNPFC input format indicator; and storing the bitstream in a non-transitory computer-readable recording medium.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of deriving luma channels from a luma component.

FIG. 2 is a block diagram showing an example video processing system.

FIG. 3 is a block diagram of an example video processing apparatus.

FIG. 4 is a flowchart for an example method of video processing in accordance with an embodiment of the disclosure.

FIG. 5 is a block diagram that illustrates an example video coding system.

FIG. 6 is a block diagram that illustrates an example encoder.

FIG. 7 is a block diagram that illustrates an example decoder.

FIG. 8 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, H.266 terminology is used in some description only for ease of understanding and not for limiting scope of the disclosed techniques. As such, the techniques described herein are applicable to other video codec protocols and designs also. In the present disclosure, editing changes are shown with respect to the Versatile Video Coding (VVC) specification.

### 1. Summary

This disclosure is related to image/video coding technologies. Specifically, it is related to the value ranges and coding methods of neural-network post-filter (NNPF) syntax elements, and is related to coding methods of indicator syntax element in NNPF supplemental enhancement information (SEI) messages. The ideas may be applied individually or in various combinations, for video bitstreams coded by any codec, e.g., the versatile video coding (VVC) standard and/or the versatile SEI messages for coded video bitstreams (VSEI) standard.

### 2. Acronyms

The following acronyms may be used herein. Adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), Internet Engineering Task Force (IETF), network abstraction layer (NAL), picture parameter set (PPS), picture unit (PU), random access skipped leading (RASL) picture, supplemental enhancement information (SEI), step-wise temporal sublayer access (STSA), uniform resource identifier (URI), video coding layer (VCL), versatile supplemental enhancement information as described in Rec. ITU-T H.274|ISO/IEC 23002-7 (VSEI), video usability information (VUI), and versatile video coding as described in Rec. ITU-T H.266| ISO/IEC 23090-3 (VVC)

### 3. Further Discussion

### 3.1 Video Coding Standards

Video coding standards have evolved primarily through the development of the well-known International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/HEVC [1]standards. Since H.262, the video coding standards are based on the hybrid video coding structure wherein temporal prediction plus transform coding are utilized. To explore the future video coding technologies beyond High Efficiency Video Coding (HEVC), the Joint Video Exploration Team (JVET) was founded by video coding experts group (VCEG) and MPEG jointly in 2015. Since then, many new methods have been adopted by JVET and put into the reference software named Joint Exploration Model (JEM) [2]. The JVET was later renamed to be the Joint Video Experts Team (JVET) when the Versatile Video Coding (VVC) project officially started. VVC [3] is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266| ISO/IEC 23090-3) [3] and the associated Versatile Supplemental Enhancement Information for coded video bitstreams (VSEI) standard (ITU-T H.274 ISO/IEC 23002-7) [4] have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 3.2 SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D ofVVC specifies syntax and semantics for SEI message payloads for some SEI messages, and specifies the use of the SEI messages and VUI parameters for which the syntax and semantics are specified in ITU-T H.274|ISO/IEC 23002-7.

### 3.3 Signalling of Neural-Network Post Filters

JVET-AD2006 [5] includes the specification of two SEI messages for signalling of neural-network post-filters, namely the neural-network post-filter characteristics (NNPFC) SEI message and the neural-network post-filter activation (NNPFA) SEI. JVET-AD2005 [6] includes the specification of the use of the NNPFC SEI message in VVC bitstreams.

The specification of NNPFC and NNPFA SEI messages in JVET-AD2006 and the specification of the use of the NNPFC SEI message in VVC bitstreams are as follows. In addition, Working Group (WG) 05 output document N0158 [5] and JVET-AC2032 [6] include the specification of two SEI messages for signalling of neural-network post-filters, as follows.

### 8.28 Neural-Network Post-Filter SEI Messages

### 8.28.1 General Post-Processing Filtering Process Using NNPFs

### 8.28.1.1 General

Input to this process is a bitstream BitstreamToFilter. Output of this process is a list ofNNPF output pictures ListNnpfOutputPics.

First, BitstreamToFilter is decoded, and the list CroppedDecodedPictures is set to be the list of the cropped decoded pictures in output order resulted from decoding BitstreamToFilter.

Second, the filtering process for one picture, as specified in subclause 8.28.1.2, is repeatedly invoked, in output order, for each cropped decoded picture that is in CroppedDecodedPictures and for which one or more NNPFs are activated.

The order of the pictures in ListNnpfOutputPics is in output order.

Within ListNnpfOutputPics there shall be no more than one picture pertaining to any particular output time instance. When for any particular picture in CroppedDecodedPictures there are multiple NNPFs activated and only one the NNPFs is allowed to be chosen to be applied although any of the NNPFs may be chosen, the above constraint shall apply regardless of which NNPF is chosen to be applied to the particular picture. 8.28.1.2 Filtering process for one picture using an NNPF

The filtering process specified in this subclause applies to each cropped decoded picture, referred to as the current picture, that is in CroppedDecodedPictures and for which one or more NNPFs are activated.

When applying an NNPF to the current picture, the filtered and/or interpolated pictures are generated by the NNPF by applying the NNPF process specified in the semantics of the NNPFC SEI message, in a patch-wise manner, to the current picture.

When applying an NNPF to the current picture, the order of the pictures generated by the NNPF by applying the NNPF process being stored into the output tensor of the NNPF is in output order.

When the applied NNPF is the last NNPF that is applied to the current picture, the pictures generated by the NNPF and output by the NNPF process are included into ListNnpfOutputPics, in the same order as when the pictures are stored into the output tensor of the NNPF.

### 8.28.2 Neural-Network Post-Filter Characteristics SF1 Message

### 8.28.2.1 Neural-Network Post-Filter Characteristics SF1 Message Syntax

| | De- |
|---|---|
| | scriptor |
| nn_post_filter_characteristics( payloadSize ) { | |
| nnpfc_purpose | u(16) |
| nnpfc_id | ue(v) |
| nnpfc_base_flag | u(1) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_property_present_flag | u(1) |
| if( nnpfc_property_present_flag ) { | |
| /* input and output formatting */ | |
| nnpfc_num_input_pics_minus1 | ue(v) |
| if( nnpfc_num_input_pics_minus1 > 0 ) { | |
| for( i = 0; i <= nnpfc_num_input_pics_minus1; i++ ) | |
| nnpfc_input_pic_output_flag[ i ] | u(1) |
| nnpfc_absent_input_pic_zero_flag | u(1) |
| } | |
| if( chromaUpsamplingFlag ) | |
| nnpfc_out_sub_c_flag | u(1) |
| if( colourizationFlag ) | |
| nnpfc_out_colour_format_idc | u(2) |
| if( resolutionResamplingFlag ) { | |
| nnpfc_pic_width_num_minus1 | ue(v) |
| nnpfc_pic_width_denom_minus1 | ue(v) |
| nnpfc_pic_height_num_minus1 | ue(v) |
| nnpfc_pic_height_denom_minus1 | ue(v) |
| } | |
| if( pictureRateUpsamplingFlag ) | |
| for( i = 0; i < nnpfc_num_input_pics_minus1; i++ ) | |
| nnpfc_interpolated_pics[ i ] | ue(v) |
| nnpfc_component_last_flag | u(1) |
| nnpfc_inp_format_idc | ue(v) |
| nnpfc_auxiliary_inp_idc | ue(v) |
| nnpfc_inp_order_idc | ue(v) |
| if( nnpfc_inp_format_idc = = 1 ) { | |
| if( nnpfc_inp_order_idc != 1 ) | |
| nnpfc_inp_tensor_luma_bitdepth_minus8 | ue(v) |
| if( nnpfc_inp_order_idc != 0 ) | |
| nnpfc_inp_tensor_chroma_bitdepth_minus8 | ue(v) |
| } | |
| nnpfc_out_format_idc | ue(v) |
| nnpfc_out_order_idc | ue(v) |
| if( nnpfc_out_format_idc = = 1 ) { | |
| if( nnpfc_out_order_idc != 1 ) | |
| nnpfc_out_tensor_luma_bitdepth_minus8 | ue(v) |
| if( nnpfc_out_order_idc != 0 ) | |
| nnpfc_out_tensor_chroma_bitdepth_minus8 | ue(v) |
| } | |
| nnpfc_separate_colour_description_present_flag | u(1) |
| if( nnpfc_separate_colour_description_present_flag ) { | |
| nnpfc_colour_primaries | u(8) |
| nnpfc_transfer_characteristics | u(8) |
| if( nnpfc_out_format_idc = = 1 ) { | |
| nnpfc_matrix_coeffs | u(8) |
| nnpfc_full_range_flag | u(1) |
| } | |
| } | |
| nnpfc_chroma_loc_info_present_flag | u(1) |
| if( nnpfc_chroma_loc_info_present_flag ) | |
| nnpfc_chroma_sample_loc_type_frame | ue(v) |
| nnpfc_overlap | ue(v) |
| nnpfc_constant_patch_size_flag | u(1) |
| if( nnpfc_constant_patch_size_flag ) { | |
| nnpfc_patch_width_minus1 | ue(v) |
| nnpfc_patch_height_minus1 | ue(v) |
| } else { | |
| nnpfc_extended_patch_width_cd_delta_minus1 | ue(v) |
| nnpfc_extended_patch_height_cd_delta_minus1 | ue(v) |
| } | |
| nnpfc_padding_type | ue(v) |
| if( nnpfc_padding_type = = 4 ) { | |
| if( nnpfc_inp_order_idc != 1 ) | |
| nnpfc_luma_padding_val | ue(v) |
| if( nnpfc_inp_order_idc != 0 ) { | |
| nnpfc_cb_padding_val | ue(v) |
| nnpfc_cr_padding_val | ue(v) |
| } | |
| } | |
| nnpfc_complexity_info_present_flag | u(1) |
| if( nnpfc_complexity_info_present_flag ) { | |
| nnpfc_parameter_type_idc | u(2) |
| if( nnpfc_parameter_type_idc != 2 ) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| nnpfc_metadata_extension_num_bits | ue(v) |
| if( nnpfc_metadata_extension_num_bits > 0 ) | |
| nnpfc_reserved_metadata_extension | u(v) |
| } | |
| /* ISO/IEC 15938-17 bitstream */ | |
| if( nnpfc_mode_idc = = 0 ) { | |
| while( !byte_aligned( ) ) | |
| nnpfc_reserved_zero_bit_b | u(1) |
| for( i = 0; more_data_in_payload( ); i++ ) | |
| nnpfc_payload_byte[ i ] | b(8) |
| } | |
| } | |

### 8.28.2.2 Neural-Network Post-Filter Characteristics SF1 Message Semantics

The neural-network post-filter characteristics (NNPFC) SF1 message specifies a neural network that may be used as a post-processing filter. The use of specified neural-network post-processing filters (NNPFs) for specific pictures is indicated with neural-network post-filter activation (NNPFA) SF1 messages.

Use of this SF1 message requires the definition of the following variables:
Input picture width and height_in units of luma_samples, denoted herein by CroppedWidth and CroppedHeight, respectively.
Luma sample array CroppedYPic[idx] and chroma sample arrays CroppedCbPic[idx] and CroppedCrPic[idx], when present, of the input pictures with index idx in the range of 0 to numInputPics−1, inclusive, that are used as input for the NNPF.
Bit depth BitDepthy for the luma sample array of the input pictures.
Bit depth BitDepthc for the chroma sample arrays, if any, of the input pictures.
A chroma format indicator, denoted herein by ChromaFormatIdc, as described in subclause 7.3.
When nnpfc_auxiliary_inp_idc is equal to 1, a filtering strength control value array StrengthControlVal[idx] that shall contain real numbers in the range of 0 to 1, inclusive, of the input pictures with index idx in the range of 0 to numInputPics−1, inclusive.

Input picture with index 0 corresponds to the picture for which the NNPF defined by this NNPFC SEI message is activated by an NNPFA SEI message. Input picture with index i in the range of 1 to numInputPics−1, inclusive, precedes the input picture with index i-1 in output order.

The variables SubWidthC and SubHeightC are derived from ChromaFormatIdc as specified by Table 1.

NOTE 1—More than one NNPFC SEI message can be present for the same picture. When more than one NNPFC SEI message with different values of nnpfc_id is present or activated for the same picture, they can have the same or different values of nnpfc_purpose and nnpfc_mode_idc.

nnpfc_purpose indicates the purpose of the NNPF as specified in Table 1, where (nnpfc_purpose & bitMask) not equal to 0 indicates that the NNPF has the purpose associated with the bitMask value in Table 1. When nnpfc_purpose is greater than 0 and (nnpfc_purpose & bitMask) is equal to 0, the purpose associated with the bitMask value is not applicable to the NNPF. When nnpfc_pupose is equal to 0, the NNPF may be used as determined by the application.

The value of nnpfc_purpose shall be in the range of 0 to 63, inclusive, in bitstreams conforming to this edition of this document. Values of 64 to 65,535, inclusive, for nnpfc_purpose are reserved for future use by ITU-T| ISO/IEC and shall not be present in bitstreams conforming to this edition of this document. Decoders conforming to this edition of this document shall ignore NNPFC SEI messages with nnpfc_purpose in the range of 64 to 65,535, inclusive.

TABLE 1
Definition of nnpfc_purpose

| bitMask | Interpretation |
|---|---|
| 0x01 | General visual quality improvement |
| 0x02 | Chroma upsampling (from the 4:2:0 chroma format to |
| | the 4:2:2 or 4:4:4 chroma format, or from the 4:2:2 |
| | chroma format to the 4:4:4 chroma format) |
| 0x04 | Resolution resampling (increasing or decreasing |
| | the width or height) |
| 0x08 | Picture rate upsampling |
| 0x10 | Bit depth upsampling (increasing the luma bit depth |
| | or the chroma bit depth) |
| 0x20 | Colourization |

The variables chromaUpsamplingFlag, resolutionResamplingFlag, pictureRateUpsamplingFlag, bitDepthUpsamplingFlag, and colourizationFlag, specifying whether nnpfc_purpose indicates the purpose of the NNPF to include chroma upsampling, resolution resampling, picture rate upsampling, bit depth upsampling, and colourization, respectively, are derived as follows:

$$chromaUpsamplingFlag = ( ( nnpfc\_purpose \& 0 \times 02 ) > 0 ) ? 1 : 0 \\ resolutionResamplingFlag = ( ( nnpfc\_purpose \& 0 \times 04 ) > 0 ) ? 1 : 0 \\ pictureRateUpsamplingFlag = ( ( nnpfc\_purpose \& 0 \times 08 ) > 0 ) ? 1 : 0 \\ bitDepthUpsamplingFlag = ( ( nnpfc\_purpose \& 0 \times 10 ) > 0 ) ? 1 : 0 \\ colourizationFlag = ( ( nnpfc\_purpose \& 0 \times 20 ) > 0 ) ? 1 : 0 \qquad ( 76 )$$

NOTE 2—When a reserved value of nnpfc_purpose is taken into use in the future by ITU-T ISO/JEC, the syntax of this SEI message could be extended with syntax elements whose presence is conditioned by nnpfc_purpose being equal to that value.

When ChromaFormatIdc is equal to 3, chromaUpsamplingFlag shall be equal to 0.

When ChromaFormatIdc or chromaUpsamplingFlag is not equal to 0, colourizationFlag shall be equal to 0.

When pictureRateUpsamplingFlag is equal to 1 and the input picture with index 0 is associated with a frame packing arrangement SEI message with fp_arrangement_type equal to 5, all input pictures are associated with a frame packing arrangement SEI message with fp_arrangement_type equal to 5 and the same value of fp_current_frame_is_frame0_flag.

nnpfc_id contains an identifying number that may be used to identify an NNPF. The value of nnpfc_id shall be in the range of 0 to 2³²-2, inclusive. Values of nnpfc_id from 256 to 511, inclusive, and from 2³¹ to 2³²−2, inclusive, are reserved for future use by ITU-T| ISO/JEC. Decoders conforming to this edition of this document encountering an NNPFC SEI message with nnpfc_id in the range of 256 to 511, inclusive, or in the range of 2³¹ to 2³²-2, inclusive, shall ignore the SEI message.

When an NNPFC SEI message is the first NNPFC SEI message, in decoding order, that has a particular nnpfc_id value within the current CLVS, the following applies:
This SEI message specifies a base NNPF.
This SEI message pertains to the current decoded picture and all subsequent decoded pictures of the current layer, in output order, until the end of the current CLVS.

nnpfc_base_flag equal to 1 specifies that the SEI message specifies the base NNPF. nnpf_base_flag equal to 0 specifies that the SEI message specifies an update relative to the base NNPF.

The following constraints apply to the value of nnpfc_base_flag:
When an NNPFC SEI message is the first NNPFC SEI message, in decoding order, that has a particular nnpfc_id value within the current CLVS, the value of nnpfc_base_flag shall be equal to 1.
When an NNPFC SEI message nnpfcB is not the first NNPFC SEI message, in decoding order, that has a particular nnpfc_id value within the current CLVS and the value ofnnpfc_base_flag is equal to 1, the NNPFC SEI message shall be a repetition of the first NNPFC SEI message nnpfcA with the same nnpfc_id value, in decoding order, i.e., the payload content of nnpfcB shall be the same as that of nnpfcA.

When nnpfc_base_flag is equal to 0, the following applies:
This SEI message defines an update relative to the preceding base NNPF in decoding order with the same nnpfc_id value. Updates are not cumulative but rather each update is applied on the base NNPF, which is the NNPF specified by the first NNPFC SEI message, in decoding order, that has a particular nnpfc_id value within the current CLVS. The NNPF defined by this SEI message is obtained by applying the update defined by this SEI message relative to the base NNPF with the same nnpfc_id value.
This SEI message pertains to the current decoded picture and all subsequent decoded pictures of the current layer, in output order, until the end of the current CLVS or up to but excluding the decoded picture that follows the current decoded picture in output order within the current CLVS and is associated with a subsequent NNPFC SEI message, in decoding order, having nnpfc_base_flag equal to 0 and that particular nnpfc_id value within the current CLVS, whichever is earlier.

nnpfc_mode_idc equal to 0 indicates that this SEI message contains an ISO/IEC 15938-17 bitstream that specifies a base NNPF (when nnpfc_base_flag is equal to 1) or is an update relative to the base NNPF with the same nnpfc_id value (when nnpfc_base_flag is equal to 0).

When nnpfc_base_flag is equal to 1, nnpfc_mode_idc equal to 1 specifies that the base NNPF associated with the nnpfc_id value is a neural network identified by the URI indicated by nnpfc_uri with the format identified by the tag URI nnpfc_tag_uri.

When nnpfc_base_flag is equal to 0, nnpfc_mode_idc equal to 1 specifies that an update relative to the base NNPF with the same nnpfc_id value is defined by the URI indicated by nnpfc_uri with the format identified by the tag URI nnpfc_tag_uri.

The value of nnpfc_mode_idc shall be in the range of 0 to 1, inclusive, in bitstreams conforming to this edition of this document. Values of 2 to 255, inclusive, for nnpfc_mode_idc are reserved for future use by ITU-T| ISO/IEC and shall not be present in bitstreams conforming to this edition of this document. Decoders conforming to this edition of this document shall ignore NNPFC SEI messages with nnpfc_mode_idc in the range of 2 to 255, inclusive. Values of nnpfc_mode_idc greater than 255 shall not be present in bitstreams conforming to this edition of this document and are not reserved for future use.

nnpfc_reserved_zero_bit_a shall be equal to 0 in bitstreams conforming to this edition of this document. Decoders shall ignore NNPFC SEI messages in which nnpfc_reserved_zero_bit_a is not equal to 0.

nnpfc_tag_uri contains a tag URI with syntax and semantics as specified in IETF RFC 4151 identifying the format and associated information about the neural network used as a base NNPF or an update relative to the base NNPF with the same nnpfc_id value specified by nnpfc_uri.

NOTE 3—nnpfc_tag_uri enables uniquely identifying the format of neural network data specified by nnrpf uri without needing a central registration authority.

nnpfc_tag_uri equal to “tag:iso.org, 2023:15938-17” indicates that the neural network data identified by nnpfc_uri conforms to ISO/IEC 15938-17.

nnpfc_uri contains a URI with syntax and semantics as specified in IETF Internet Standard 66 identifying the neural network used as a base NNPF or an update relative to the base NNPF with the same nnpfc_id value.

nnpfcpropertypresent_flag equal to 1 specifies that syntax elements related to the filter purpose, input formatting, output formatting, and complexity are present. nnpfcproperrypresent_flag equal to 0 specifies that no syntax elements related to the filter purpose, input formatting, output formatting, and complexity are present.

When nnpfc_base_flag is equal to 1, nnpfc_property_present_flag shall be equal to 1.

When nnpfcpropertypresent_flag is equal to 0, the values of all syntax elements that may be present only when nnpfcpropertypresent_flag is equal to 1 are inferred to be equal to their corresponding syntax elements, respectively, in the NNPFC SEI message that contains the base NNPF for which this SEI message provides an update.

When an NNPFC SEI message nnpfcCurr is not the first NNPFC SEI message, in decoding order, that has a particular nnpfc_id value within the current CLVS, is not a repetition of the first NNPFC SEI message with that particular nnpfc_id (i.e., the value of nnpfc_base_flag is equal to 0), and the value of nnpfcpropertypresent_flag is equal to 1, the following constraints apply:
The value of nnpfcpurpose in the NNPFC SEI message shall be the same as the value of nnpfcpurpose in the first NNPFC SEI message, in decoding order, that has that particular nnpfc_id value within the current CLVS.
The values of syntax elements following nnpfcpropertypresent_flag and preceding nnpfc_complexity_infopresent_flag, in decoding order, in the NNPFC SEI message shall be the same as the values of corresponding syntax elements in the first NNPFC SEI message, in decoding order, that has that particular nnpfc_id value within the current CLVS.
Either nnpfc_complexity_info_present_flag shall be equal to 0 or both nnpfc_complexity_info_present_flag shall be equal to 1 in the first NNPFC SEI message, in decoding order, that has that particular nnpfc_id value within the current CLVS (denoted as nnpfcBase below) and all the following apply:
nnpfc_parameter_type_idc in nnpfcCurr shall be equal to nnpfc_parameter_type_idc in nnpfcBase.
nnpfc_log 2_parameter_bit_length_minus3 in nnpfcCurr, when present, shall be less than or equal to nnpfc_log 2_parameter_bit_length_minus3 in nnpfcBase.
If nnpfc_num_parameters_idc in nnpfcBase is equal to 0, nnpfc_num_parameters_idc in nnpfcCurr shall be equal to 0.
Otherwise (nnpfc_num_parameters_idc in nnpfcBase is greater than 0), nnpfc_num_parameters_idc in nnpfcCurr shall be greater than 0 and less than or equal to nnpfc_num_parameters_idc in nnpfcBase.
If nnpfc_num_kmac_operations_idc in nnpfcBase is equal to 0, nnpfc_num_kmac_operations_idc in nnpfcCurr shall be equal to 0.
Otherwise (nnpfc_num_kmac_operations_idc in nnpfcBase is greater than 0), nnpfc_num_kmac_operations_idc in nnpfcCurr shall be greater than 0 and less than or equal to nnpfc_num_kmac_operations_idc in nnpfcBase.
If nnpfc_total_kilobyte_size in nnpfcBase is equal to 0, nnpfc_total_kilobyte_size in nnpfcCurr shall be equal to 0.
Otherwise (nnpfc_total_kilobyte_size in nnpfcBase is greater than 0), nnpfc_total_kilobyte_size in nnpfcCurr shall be greater than 0 and less than or equal to nnpfc_total_kilobyte_size in nnpfcBase.

nnpfc_num_input_pics_minus1 plus 1 specifies the number of pictures used as input for the NNPF. The value of nnpfc_num_input_pics_minus1 shall be in the range of 0 to 63, inclusive. When pictureRateUpsamplingFlag is equal to 1, the value of nnpfc_num_input_pics_minus1 shall be greater than 0.

The variable numInputPics, specifying the number of pictures used as input for the NNPF, is derived as follows:

$$numImputPics = nnpfc\_num \_input \_pics \_minus1 + 1 \qquad ( 77 )$$

nnpfc_input_pic_output_flag[i] equal to 1 indicates that for the i-th input picture the NNPF generates a corresponding output picture. nnpfc_input_pic_output_flag[i] equal to 0 indicates that for the i-th input picture the NNPF does not generate a corresponding output picture. When nnpfc_num_input_pics_minus1 is equal to 0, nnpfc_input_pic_output_flag[0] is inferred to be equal to 1. When pictureRateUpsamplingFlag is equal to 0 and nnpfc_num_input_pics_minus1 is greater than 0, nnpfc_input_pic_output_flag[i] shall be equal to 1 for at least one value of i in the range of 0 to nnpfc_num_input_pics_minus1, inclusive.

nnpfc_absent_input_pic_zero_flag equal to 1 indicates that the NNPF expects an input picture that is not present in the bitstream to be represented by sample arrays with sample values equal to 0. nnpfc_absent_input_pic_zero_flag equal to 0 indicates that the NNPF expects an input picture that is not present in the bitstream to be represented by the closest input picture in output order within the bitstream.

nnpfc_out_subc_flag specifies the values of the variables outSubWidthC and outSubHeightC when chromaUpsamplingFlag is equal to 1. nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When ChromaFormatIdc is equal to 2 and nnpfc_out_sub_c_flag is present, the value of nnpfc_out_sub_c_flag shall be equal to 1.

nnpfc_out_colour_format_idc, when colourizationFlag is equal to 1, specifies the colour format of the NNPF output and consequently the values of the variables outSubWidthC and outSubHeightC. nnpfc_out_colour_format_idc equal to 1 specifies that the colour format of the NNPF output is the 4:2:0 format and outSubWidthC and outSubHeightC are both equal to 2. nnpfc_out_colour_format_idc equal to 2 specifies that the colour format of the NNPF output is the 4:2:2 format and outSubWidthC is equal to 2 and outSubHeightC is equal to 1. nnpfc_out_colour_format_idc equal to 3 specifies that the colour format of the NNPF output is the 4:4:4 format and outSubWidthC and outSubHeightC are both equal to 1. The value of nnpfc_out_colour_format_idc shall not be equal to 0.

When chromaUpsamplingFlag and colourizationFlag are both equal to 0, outSubWidthC and outSubHeightC are inferred to be equal to SubWidthC and SubHeightC, respectively.

nnpfc_pic_width_num_minus1 plus 1 and nnpfc_pic_width_denom_minus1 plus 1 specify the numerator and denominator, respectively, for the resampling ratio of the NNPF output picture width relative to CroppedWidth. The value of (nnpfc_pic_width_num_minus1+1)÷(nnpfc_pic_width_denom_minus1+1) shall be in the range of 1÷16 to 16, inclusive. When nnpfc_pic_width_num_minus1 and nnpfc_pic_width_denom_minus1 are not present, the values of nnpfc_pic_width_num_minus1 and nnpfc_pic_width_denom_minus1 are both inferred to be equal to 0.

The variable nnpfcOutputPicWidth, representing the width of the luma sample arrays of the picture(s) resulting from applying the NNPF identified by nnpfc_id to the input picture(s), is derived as follows:

$$nnpfcOutputPicWidth = Ceil ( CroppedWidth * ( nnpfc\_pic \_width \_num \_minus1 + 1 ) \div ( nnpfc\_pic \_width \_denom \_minus1 + 1 ) ) \qquad ( 78 )$$

It is a requirement of bitstream conformance that the value of nnpfcOutputPicWidth % outSubWidthC shall be equal to 0.

nnpfc_pic_height_num_minus1 plus 1 and nnpfc_pic_height_denom_minus1 plus 1 specify the numerator and denominator, respectively, for the resampling ratio of the NNPF output picture height relative to CroppedHeight. The value of (nnpfc_pic_height_num_minus1+1)+(nnpfc_pic_height_denom_minus1+1) shall be in the range of 1÷16 to 16, inclusive. When nnpfc_pic_height_num_minus1 and nnpfc_pic_height_denom_minus1 are not present, the values of nnpfc_pic_height_num_minus1 and nnpfc_pic_height_denom_minus1 are both inferred to be equal to 0.

The variable nnpfcOutputPicHeight, representing the height of the luma sample arrays of the picture(s) resulting from applying the NNPF identified by nnpfc_id to the input picture(s), is derived as follows:

$$nnpfcOutputPicHeight = Ceil ( CroppedHeight * ( nnpfc\_pic \_height \_num \_minus1 + 1 ) \div ( nnpfc\_pic \_height \_denom \_minus1 + 1 ) ) \qquad ( 79 )$$

It is a requirement of bitstream conformance that the value of nnpfcOutputPicHeight % outSubHeightC shall be equal to 0.

When nnpfc_pic_width_num_minus1, nnpfc_pic_width_denom_minus1, nnpfc_pic_height_num_minus1, and nnpfc_pic_height_denom_minus1 are present, at least one the following shall be true:
The value of nnpfcOutputPicWidth is not equal to CroppedWidth.
The value of nnpfcOutputPicHeight is not equal to CroppedHeight.

nnpfc_interpolated_pics[i] specifies the number of interpolated pictures generated by the NNPF between the i-th and the (i+1)-th picture used as input for the NNPF. The value of nnpfc_interpolated_pics[i] shall be in the range of 0 to 63, inclusive. The value of nnpfc_interpolated_pics[i] shall be greater than 0 for at least one value of i in the range of 0 to nnpfc_num_input_pics_minus1−1, inclusive.

The variables NumInpPicsInOutputTensor, specifying the number of pictures that have a corresponding input picture and are present in the output tensor of the NNPF, Inpldx[idx] specifying the input picture index of the idx-th picture that is present in the output tensor of the NNPF and has a corresponding input picture, and numOutputPics, specifying the total number of pictures present in the output tensor of the NNPF, are derived as follows:

| for( i = 0, numOutputPics = 0; i < numInputPics; i++ ) | |
|---|---|
| if( nnpfc_input_pic_output_flag[ i ] ) { | |
| InpIdx[ numOutputPics ] = i | |
| numOutputPics++ | |
| } | (80) |

NumInpPicsInOutputTensor = numOutputPics
if( pictureRateUpsamplingFlag )
for( i = 0; i <= numInputPics − 2; i++ )
numOutputPics += nnpfc_interpolated_pics[ i ]

nnpfc_component_last_flag equal to 1 indicates that the last dimension in the input tensor inputTensor to the NNPF and the output tensor outputTensor resulting from the NNPF is used for a current channel. nnpfc_component_last_flag equal to 0 indicates that the third dimension in the input tensor inputTensor to the NNPF and the output tensor outputTensor resulting from the NNPF is used for a current channel.

NOTE 4—The first dimension in the input tensor and in the output tensor is used for the batch index, which is a practice in some neural network frameworks. While formulae in the semantics of this SEI message use the batch size corresponding to the batch index equal to 0, it is up to the post-processing implementation to determine the batch size used as input to the neural network inference.

NOTE 5—For example, when nnpfc_inp_order_idc is equal to 3 and nnpfc_auxiliary_inp_idc is equal to 1, there are 7 channels in the input tensor, including four luma matrices, two chroma matrices, and one auxiliary input matrix. In this case, the process DeriveInputTensors( ) would derive each of these 7 channels of the input tensor one by one, and when a particular channel of these channels is processed, that channel is referred to as the current channel during the process.

nnpfc_inp_format_idc indicates the method of converting a sample value of the input picture to an input value to the NNPF. When nnpfc_inp_format_idc is equal to 0, the input values to the NNPF are real numbers and the functions InpY( ) and InpC( ) are specified as follows:

$$InpY ( x ) = x \div ( ( 1 << {BitDept h}_{Y} ) - 1 ) \qquad ( 81 )$$

$$InpC ( x ) = x \div ( ( 1 << {BitDepth}_{C} ) - 1 ) \qquad ( 82 )$$

When nnpfc_inp_format_idc is equal to 1, the input values to the NNPF are unsigned integer numbers and the functions InpY( ) and InpC( ) are specified as follows:

shiftY = BitDepth_{Y} − inpTensorBitDepth_{Y}
if( inpTensorBitDepth_{Y} >= BitDepth_{Y})

| | |
|---|---|
| InpY( x ) = x << ( inpTensorBitDepth_{Y} − BitDepth_{Y} ) | (83) |

else
InpY( x ) = Clip3(0, ( 1 << inpTensorBitDepth_{Y} ) − 1, ( x + ( 1 << (
shiftY − 1 ) ) ) >> shiftY )
shiftC = BitDepth_{C} − inpTensorBitDepth_{C}
if( inpTensorBitDepth_{C} >= BitDepth_{C} )

| | |
|---|---|
| InpC( x ) = x << ( inpTensorBitDepth_{C} − BitDepth_{C} ) | (84) |

else
InpC( x ) = Clip3(0, ( 1 << inpTensorBitDepth_{C} ) − 1, ( x + ( 1 << (
shiftC − 1 ) ) ) >> shiftC )

The variable inpTensorBitDepthY is derived from the syntax element nnpfc_inp_tensor_luma_bitdepth_minus8 as specified below. The variable inpTensorBitDepthC is derived from the syntax element nnpfc_inp_tensor_chroma_bitdepth_minus8 as specified below.

Values of nnpfc_inp_format_idc greater than 1 are reserved for future specification by ITU-T ISO/JEC and shall not be present in bitstreams conforming to this edition of this document. Decoders conforming to this edition of this document shall ignore NNPFC SEI messages that contain reserved values of nnpfc_inp_format_idc.

nnpfc_auxiliary_inp_idc greater than 0 indicates that auxiliary input data is present in the input tensor of the NNPF. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 85.

The value of nnpfc_auxiliary_inp_idc shall be in the range of 0 to 1, inclusive, in bitstreams conforming to this edition of this document. Values of 2 to 255, inclusive, for nnpfc_auxiliary_inp_idc are reserved for future use by ITU-T| ISO/JEC and shall not be present in bitstreams conforming to this edition of this document. Decoders conforming to this edition of this document shall ignore NNPFC SEI messages with nnpfc_auxiliary_inp_idc in the range of 2 to 255, inclusive. Values of nnpfc_auxiliary_inp_idc greater than 255 shall not be present in bitstreams conforming to this edition of this document and are not reserved for future use.

nnpfc_inp_order_idc indicates the method of ordering the sample arrays of an input picture to form an input tensor to the NNPF.

The value of nnpfc_inp_order_idc shall be in the range of 0 to 3, inclusive, in bitstreams conforming to this edition of this document. Values of 4 to 255, inclusive, for nnpfc_inp_order_idc are reserved for future use by ITU-T| ISO/IEC and shall not be present in bitstreams conforming to this edition of this document. Decoders conforming to this edition of this document shall ignore NNPFC SEI messages with nnpfc_inp_order_idc in the range of 4 to 255, inclusive. Values of nnpfc_inp_order_idc greater than 255 shall not be present in bitstreams conforming to this edition of this document and are not reserved for future use.

When ChromaFormatIdc is not equal to 1, nnpfc_inp_order_idc shall not be equal to 3.

When ChromaFormatIdc is equal to 0, nnpfc_inp_order_idc shall be equal to 0.

When chromaUpsamplingFlag is equal to 1, nnpfc_inp_order_idc shall not be equal to 0.

Table 2 contains an informative description ofnnpfc_inp_order_idc values.

TABLE 2
Description of nnpfc_inp_order_idc values

| nnpfc_inp_{—} | |
|---|---|
| order_idc | Description |
| 0 | If nnpfc_auxiliary_inp_idc is equal to 0, one luma |
| | matrix is present in the input tensor for each |
| | input picture, and the number of channels is 1. |
| | Otherwise, when nnpfc_auxiliary_inp_idc is equal |
| | to 1, one luma matrix and one auxiliary input matrix |
| | are present, and the number of channels is 2. |
| 1 | If nnpfc_auxiliary_inp_idc is equal to 0, two chroma |
| | matrices are present in the input tensor, and the |
| | number of channels is 2. Otherwise, when |
| | nnpfc_auxiliary_inp_idc is equal to 1, two chroma |
| | matrices and one auxiliary input matrix are |
| | present, and the number of channels is 3. |
| 2 | If nnpfc_auxiliary_inp idc is equal to 0, one luma |
| | and two chroma matrices are present in the input |
| | tensor, and the number of channels is 3. Otherwise, |
| | when nnpfc_auxiliary_inp_idc is equal to 1, one luma |
| | matrix, two chroma matrices and one auxiliary input |
| | matrix are present, and the number of channels is 4. |
| 3 | If nnpfc_auxiliary_inp_idc is equal to 0, four luma |
| | matrices and two chroma matrices are present in |
| | the input tensor, and the number of channels is 6. |
| | Otherwise, when nnpfc_auxiliary_inp_idc is equal |
| | to 1, four luma matrices, two chroma matrices, and one |
| | auxiliary input matrix are present in the input tensor, |
| | and the number of channels is 7. The luma channels are |
| | derived in an interleaved manner as illustrated in |
| | FIG. 12. This nnpfc_inp_order_idc can only be used |
| | when the input chroma format is 4:2:0. |
| 4 . . . 255 | Reserved |

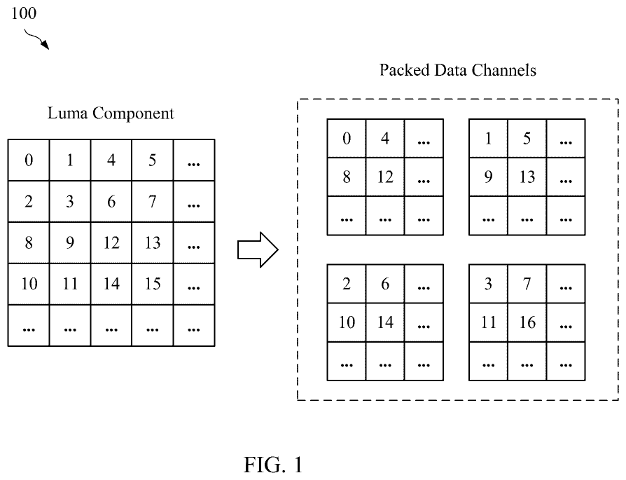

FIG. 1 illustrates an example of deriving luma channels from a luma component. For example, four luma channels (right) are derived from the luma component (left) when nnpfc_inp_order_idc is equal to 3.

nnpfc_inp_tensor_luma_bitdepth_minus8 plus 8 specifies the bit depth of luma sample values in the input integer tensor. The value of inpTensorBitDepthY is derived as follows:

$$inpTensorB {itDepth}_{Y} = nnpfc\_inp \_tensor \_luma \_bitdepth \_minus8 + 8 \qquad ( 85 )$$

It is a requirement of bitstream conformance that the value of nnpfc_inp_tensor_luma_bitdepth_minus8 shall be in the range of 0 to 24, inclusive.

nnpfc_inp_tensor_chroma_bitdepth_minus8 plus 8 specifies the bit depth of chroma sample values in the input integer tensor. The value of inpTensorBitDepthC is derived as follows:

$$inpTensorB itDepthC = nnpfc\_inp \_tensor \_chroma \_bitdepth \_minus8 + 8 \qquad ( 86 )$$

It is a requirement of bitstream conformance that the value of nnpfc_inp_tensor_chroma_bitdepth_minus8 shall be in the range of 0 to 24, inclusive.

When nnpfc_auxiliary_inp_idc is equal to 1, the variable strengthControlScaledVal is derived as follows:

for( i = 0; i < numInputPics; i++ )

| | |
|---|---|
| if( nnpfc_inp_format_idc = = 1 ) | (87) |

```
    if( nnpfc_inp_order_idc = = 0 ∥ nnpfc_inp_order_idc = = 2 ∥
        nnpfc_inp_order_idc = = 3 )
      strengthControlScaledVal[ i ] =
          Floor ( StrengthControlVal[ i ] * ( ( 1 << inpTensorBitDepth_{Y} ) − 1 ) )
    else if( nnpfc_inp_order_idc = = 1 )
      strengthControlScaledVal[ i ] =
          Floor ( StrengthControlVal[ i ] * ( ( 1 << inpTensorBitDepth_{C} ) − 1 ) )
  else
    strengthControlScaledVal[ i ] = StrengthControlVal[ i ]
```

A patch is a rectangular array of samples from a component (e.g., a luma or chroma component) of a picture.

The process DerivelnputTensors( ), for deriving the input tensor inputTensor for a given vertical sample coordinate cTop and a horizontal sample coordinate cLeft specifying the top-left sample location for the patch of samples included in the input tensor, is specified as follows:

```
for( i = 0; i < numInputPics; i++ ) {
  if( nnpfc_inp_order_idc = = 0 )
    for( yP = −nnpfc_overlap; yP < inpPatchHeight + nnpfc_overlap; yP++)
      for( xP = −nnpfc_overlap; xP < inpPatchWidth + nnpfc_overlap; xP++ ) {
        inpVal = InpY( InpSampleVal( cTop + yP, cLeft + xP, CroppedHeight,
            CroppedWidth, CroppedYPic[ i ], 0 ) )
        yPovlp = yP + nnpfc_overlap
        xPovlp = xP + nnpfc_overlap
        if( !nnpfc_component_last_flag )
          inputTensor[ 0 ][ i ][ 0 ][ yPovlp ][ xPovlp ] = inpVal
        else
          inputTensor[ 0 ][ i ][ yPovlp ][ xPovlp ][ 0 ] = inpVal
        if( nnpfc_auxiliary_inp_idc = = 1 )
          if( !nnpfc_component_last_flag )
            inputTensor[ 0 ][ i ][ 1 ][ yPovlp ][ xPovlp ] = strengthControlScaledVal[ i ]
          else
            inputTensor[ 0 ][ i ][ yPovlp ][ xPovlp ][ 1 ] = strengthControlScaledVal[ i ]
      }
```

| | |
|---|---|
| else if( nnpfc_inp_order_idc = = 1 ) | (88) |

```
    for( yP = −nnpfc_overlap; yP < inpPatchHeight + nnpfc_overlap; yP++)
      for( xP = −nnpfc_overlap; xP < inpPatchWidth + nnpfc_overlap; xP++ ) {
        inpCbVal = InpC( InpSampleVal( cTop + yP, cLeft + xP, CroppedHeight / SubHeightC,
            CroppedWidth / SubWidthC, CroppedCbPic[ i ], 1 ) )
        inpCrVal = InpC( InpSampleVal( cTop + yP, cLeft + xP, CroppedHeight / SubHeightC,
            CroppedWidth / SubWidthC, CroppedCrPic[ i ], 2 ) )
        yPovlp = yP + nnpfc_overlap
        xPovlp = xP + nnpfc_overlap
        if( !nnpfc_component_last_flag ) {
          inputTensor[ 0 ][ i ][ 0 ][ yPovlp ][ xPovlp ] = inpCbVal
          inputTensor[ 0 ][ i ][ 1 ][ yPovlp ][ xPovlp ] = inpCrVal
        } else {
          inputTensor[ 0 ][ i ][ yPovlp ][ xPovlp ][ 0 ] = inpCbVal
          inputTensor[ 0 ][ i ][ yPovlp ][ xPovlp ][ 1 ] = inpCrVal
        }
        if( nnpfc_auxiliary_inp_idc = = 1 )
          if( !nnpfc_component_last_flag )
            inputTensor[ 0 ][ i ][ 2 ][ yPovlp ][ xPovlp ] = strengthControlScaledVal[ i ]
          else
            inputTensor[ 0 ][ i ][ yPovlp ][ xPovlp ][ 2 ] = strengthControlScaledVal[ i ]
      }
  else if( nnpfc_inp_order_idc = = 2 )
    for( yP = −nnpfc_overlap; yP < inpPatchHeight + nnpfc_overlap; yP++)
      for( xP = −nnpfc_overlap; xP < inpPatchWidth + nnpfc_overlap; xP++ ) {
        yY = cTop + yP
        xY = cLeft + xP
        yC = yY / SubHeightC
        xC = xY / SubWidthC
        inpYVal = InpY ( InpSampleVal( yY, xY, CroppedHeight,
            CroppedWidth, CroppedYPic[ i ], 0 ) )
        inpCbVal = InpC( InpSampleVal( yC, xC, CroppedHeight / SubHeightC,
            CroppedWidth / SubWidthC, CroppedCbPic[ i ], 1 ) )
        inpCrVal = InpC( InpSampleVal( yC, xC, CroppedHeight / SubHeightC,
            CroppedWidth / SubWidthC, CroppedCrPic[ i ], 2 ) )
        yPovlp = yP + nnpfc_overlap
        xPovlp = xP + nnpfc_overlap
        if( !nnpfc_component_last_flag ) {
          inputTensor[ 0 ][ i ][ 0 ][ yPovlp ][ xPovlp ] = inpYVal
          inputTensor[ 0 ][ i ][ 1 ][ yPovlp ][ xPovlp ] = inpCbVal
          inputTensor[ 0 ][ i ][ 2 ][ yPovlp ][ xPovlp ] = inpCrVal
        } else {
          inputTensor[ 0 ][ i ][ yPovlp ][ xPovlp ][ 0 ] = inpYVal
          inputTensor[ 0 ][ i ][ yPovlp ][ xPovlp ][ 1 ] = inpCbVal
          inputTensor[ 0 ][ i ][ yPovlp ][ xPovlp ][ 2 ] = inpCrVal
        }
        if( nnpfc_auxiliary_inp_idc = = 1 )
          if( !nnpfc_component_last_flag )
            inputTensor[ 0 ][ i ][ 3 ][ yPovlp ][ xPovlp ] = strengthControlScaledVal[ i ]
          else
            inputTensor[ 0 ][ i ][ yPovlp ][ xPovlp ][ 3 ] = strengthControlScaledVal[ i ]
      }
  else if( nnpfc_inp_order_idc = = 3 )
    for( yP = −nnpfc_overlap; yP < inpPatchHeight + nnpfc_overlap; yP++)
      for( xP = −nnpfc_overlap; xP < inpPatchWidth + nnpfc_overlap; xP++ ) {
        yTL = cTop + yP * 2
        xTL = cLeft + xP *2
        yBR = yTL + 1
        xBR = xTL + 1
        yC = cTop / 2 + yP
        xC = cLeft / 2 + xP
        inpTLVal = InpY( InpSampleVal( yTL, xTL, CroppedHeight,
            CroppedWidth, CroppedYPic[ i ], 0 ) )
        inpTRVal = InpY( InpSampleVal( yTL, xBR, CroppedHeight,
            CroppedWidth, CroppedYPic[ i ], 0 ) )
        inpBLVal = InpY( InpSampleVal( yBR, xTL, CroppedHeight,
            CroppedWidth, CroppedYPic[ i ], 0 ) )
        inpBRVal = InpY( InpSampleVal( yBR, xBR, CroppedHeight,
            CroppedWidth, CroppedYPic[ i ], 0 ) )
        inpCbVal = InpC( InpSampleVal( yC, xC, CroppedHeight / 2,
            CroppedWidth / 2, CroppedCbPic[ i ], 1 ) )
        inpCrVal = InpC( InpSampleVal( yC, xC, CroppedHeight / 2,
            CroppedWidth / 2, CroppedCrPic[ i ], 2 ) )
        yPovlp = yP + nnpfc_overlap
        xPovlp = xP + nnpfc_overlap
        if( !nnpfc_component_last_flag ) {
          inputTensor[ 0 ][ i ][ 0 ][ yPovlp ][ xPovlp ] = inpTLVal
          inputTensor[ 0 ][ i ][ 1 ][ yPovlp ][ xPovlp ] = inpTRVal
          inputTensor[ 0 ][ i ][ 2 ][ yPovlp ][ xPovlp ] = inpBLVal
          inputTensor[ 0 ][ i ][ 3 ][ yPovlp ][ xPovlp ] = inpBRVal
          inputTensor[ 0 ][ i ][ 4 ][ yPovlp ][ xPovlp ] = inpCbVal
          inputTensor[ 0 ][ i ][ 5 ][ yPovlp ][ xPovlp ] = inpCrVal
        } else {
          inputTensor[ 0 ][ i ][ yPovlp ][ xPovlp ][ 0 ] = inpTLVal
          inputTensor[ 0 ][ i ][ yPovlp ][ xPovlp ][ 1 ] = inpTRVal
          inputTensor[ 0 ][ i ][ yPovlp ][ xPovlp ][ 2 ] = inpBLVal
          inputTensor[ 0 ][ i ][ yPovlp ][ xPovlp ][ 3 ] = inpBRVal
          inputTensor[ 0 ][ i ][ yPovlp ][ xPovlp ][ 4 ] = inpCbVal
          inputTensor[ 0 ][ i ][ yPovlp ][ xPovlp ][ 5 ] = inpCrVal
        }
        if( nnpfc_auxiliary_inp_idc = = 1 )
          if( !nnpfc_component_last_flag )
            inputTensor[ 0 ][ i ][ 6 ][ yPovlp ][ xPovlp ] = strengthControlScaledVal[ i ]
          else
            inputTensor[ 0 ][ i ][ yPovlp ][ xPovlp ][ 6 ] = strengthControlScaledVal[ i ]
      }
}
```

nnpfc_out_format_idc equal to 0 indicates that the sample values output by the NNPF are real numbers where the value range of 0 to 1, inclusive, maps linearly to the unsigned integer value range of 0 to (1 «bitDepth)−1, inclusive, for any desired bit depth bitDepth for subsequent post-processing or displaying.

nnpfc_out_format_idc equal to 1 indicates that the luma sample values output by the NNPF are unsigned integer numbers in the range of 0 to (1 «outTensorBitDepthY)−1, inclusive, and the chroma sample values output by the NNPF are unsigned integer numbers in the range of 0 to (1 «outTensorBitDepthC)−1, inclusive.

Values of nnpfc_out_format_idc greater than 1 are reserved for future specification by ITU-T ISO/JEC and shall not be present in bitstreams conforming to this edition of this document. Decoders conforming to this edition of this document shall ignore NNPFC SEI messages that contain reserved values of nnpfc_out_format_idc.

nnpfc_out_order_idc indicates the output order of samples resulting from the NNPF.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T| ISO/JEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When chromaUpsamplingFlag is equal to 1, nnpfc_out_order_idc shall not be equal to 0 or 3.

When colourizationFlag is equal to 1, nnpfc_out_order_idc shall not be equal to 0.

TABLE 3
contains an informative description of nnpfc_out_order_idc
values. Description of nnpfc_out_order idc values

| nnpfc_out | |
|---|---|
| order_idc | Description |
| 0 | Only the luma matrix is present in the output tensor, thus the |
| | number of channels is 1. |
| 1 | Only the chroma matrices are present in the output tensor, |
| | thus the number of channels is 2. |
| 2 | The luma and chroma matrices are present in the output |
| | tensor, thus the number of channels is 3. |
| 3 | Four luma matrices and two chroma matrices are present in |
| | the output tensor, thus the number of channels is 6. This |
| | nnpfc_out_order_idc can only be used when the output |
| | chroma format is 4:2:0. |
| 4 . . . 255 | Reserved |

nnpfc_out_tensor_luma_bitdepth_minus8 plus 8 specifies the bit depth of luma sample values in the output integer tensor. The value of nnpfc_out_tensor_luma_bitdepth_minus8 shall be in the range of 0 to 24, inclusive. The value of outTensorBitDepthY is derived as follows:

$$outTensorB {itDepth}_{Y} = nnpfc\_out \_tensor \_luma \_bitdepth \_minus8 + 8 \qquad ( 89 )$$

nnpfc_out_tensor_chroma_bitdepth_minus8 plus 8 specifies the bit depth of chroma sample values in the output integer tensor. The value of nnpfc_out_tensor_chroma_bitdepth_minus8 shall be in the range of 0 to 24, inclusive. The value of outTensorBitDepthC is derived as follows:

$$outTensorB itDepthC = nnpfc\_out \_tensor \_chroma \_bitdepth \_minus8 + 8 \qquad ( 90 )$$

When bitDepthUpsamplingFlag is equal to 1, the value of nnpfc_out_format_idc shall be equal to 1 and at least one of the following conditions shall be true:
nnpfc_out_tensor_luma_bitdepth_minus8 is present and outTensorBitDepthy is greater than BitDepthy.
nnpfc_out_tensor_chroma_bitdepth_minus8 is present and outTensorBitDepthc is greater than BitDepthc.

When nnpfc_inp_tensor_luma_bitdepth_minus8, nnpfc_inp_tensor_chroma_bitdepth_minus8, nnpfc_out_tensor_luma_bitdepth_minus8, and nnpfc_out_tensor_chroma_bitdepth_minus8 are present and outTensorBitDepthY is greater than inpTensorBitDepthY, outTensorBitDepthC shall not be less than inpTensorBitDepthC. When nnpfc_inp_tensor_luma_bitdepth_minus8, nnpfc_inp_tensor_chroma_bitdepth_minus8, nnpfc_out_tensor_luma_bitdepth_minus8, and nnpfc_out_tensor_chroma_bitdepth_minus8 are present and outTensorBitDepthC is greater than inpTensorBitDepthC, outTensorBitDepthY shall not be less than inpTensorBitDepthY.

The process StoreOutputTensors( ), for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < numOutputPics; i++ ) {
  if( nnpfc_out_order_idc = = 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfcOutputPicHeight && xY < nnpfcOutputPicWidth )
          if( !nnpfc_component_last_flag )
            FilteredYPic[ i ][ xY ][yY ] = outputTensor[ 0 ][ i ][ 0 ][ yP ][ xP ]
          else
            FilteredYPic[ i ][ xY ][ yY ] = outputTensor[ 0 ][ i ][ yP ][ xP ][ 0 ]
      }
```

| | |
|---|---|
| else if( nnpfc_out_order_idc = = 1 ) | (91) |

```
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfcOutputPicHeight / outSubHeightC &&
            xSrc < nnpfcOutputPicWidth / outSubWidthC )
          if( !nnpfc_component_last_flag ) {
            FilteredCbPic[ i ][ xSrc ][ ySrc ] = outputTensor[ 0 ][ i ][ 0 ][ yP ][ xP ]
            FilteredCrPic[ i ][ xSrc ][ ySrc ] = outputTensor[ 0 ][ i ][ 1 ][ yP ][ xP ]
          } else {
            FilteredCbPic[ i ][ xSrc ][ ySrc ] = outputTensor[ 0 ][ i ][ yP ][ xP ][ 0 ]
            FilteredCrPic[ i ][ xSrc ][ ySrc ] = outputTensor[ 0 ][ i ][ yP ][ xP ][ 1 ]
          }
      }
  else if( nnpfc_out_order_idc = = 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = ( yP / outSubHeightC ) * outSubHeightC
        xPc = (xP / outSubWidthC ) * outSubWidthC
        if ( yY < nnpfcOutputPicHeight && xY < nnpfcOutputPicWidth )
          if( !nnpfc_component_last_flag ) {
            FilteredYPic[ i ][ xY ][ yY ] = outputTensor[ 0 ][ i ][ 0 ][ yP ][ xP ]
            FilteredCbPic[ i ][ xC ][ yC ] = outputTensor[ 0 ][ i ][ 1 ][ yPc ][ xPc ]
            FilteredCrPic[ i ][ xC ][ yC ] = outputTensor[ 0 ][ i ][ 2 ][ yPc ][ xPc ]
          } else {
            FilteredYPic[ i ][ xY ][ yY ] = outputTensor[ 0 ][ i ][ yP ][ xP ][ 0 ]
            FilteredCbPic[ i ][ xC ][ yC ] = outputTensor[ 0 ][ i ][ yPc ][ xPc ][ 1 ]
            FilteredCrPic[ i ][ xC ][ yC ] = outputTensor[ 0 ][ i ][ yPc ][ xPc ][ 2 ]
          }
      }
  else if( nnpfc_out_order_idc = = 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfcOutputPicHeight / 2 &&
            xSrc < nnpfcOutputPicWidth / 2 )
          if( !nnpfc_component_last_flag ) {
            FilteredYPic[ i ][ xSrc * 2 ][ ySrc * 2 ] = outputTensor[ 0 ][ i ][ 0 ][ yP ][ xP ]
            FilteredYPic[ i ][ xSrc * 2 + 1 ][ ySrc * 2 ] = outputTensor[ 0 ][ i ][ 1 ][ yP ][ xP ]
            FilteredYPic[ i ][ xSrc * 2 ][ ySrc * 2 + 1 ] = outputTensor[ 0 ][ i ][ 2 ][ yP ][ xP ]
            FilteredYPic[ i ][ xSrc * 2 + 1][ ySrc * 2 + 1 ] = outputTensor[ 0 ][ i ][ 3 ][ yP ][ xP ]
            FilteredCbPic[ i ][ xSrc ][ ySrc ] = outputTensor[ 0 ][ i ][ 4 ][ yP ][ xP ]
            FilteredCrPic[ i ][ xSrc ][ ySrc ] = outputTensor[ 0 ][ i ][ 5 ][ yP ][ xP ]
          } else {
            FilteredYPic[ i ][ xSrc * 2 ][ ySrc * 2 ] = outputTensor[ 0 ][ i ][ yP ][ xP ][ 0 ]
            FilteredYPic[ i ][ xSrc * 2 + 1 ][ ySrc * 2 ] = outputTensor[ 0 ][ i ][ yP ][ xP ][ 1 ]
            FilteredYPic[ i ][ xSrc * 2 ][ ySrc * 2 + 1 ] = outputTensor[ 0 ][ i ][ yP ][ xP ][ 2 ]
            FilteredYPic[ i ][ xSrc * 2 + 1][ ySrc * 2 + 1 ] = outputTensor[ 0 ][ i ][ yP ][ xP ][ 3 ]
            FilteredCbPic[ i ][ xSrc ][ ySrc ] = outputTensor[ 0 ][ i ][ yP ][ xP ][ 4 ]
            FilteredCrPic[ i ][ xSrc ][ ySrc ] = outputTensor[ 0 ][ i ][ yP ][ xP ][ 5 ]
          }
      }
}
```

nnpfc_separate_colour_description_present_flag equal to 1 indicates that a distinct combination of colour_primaries, transfer characteristics, matrix coefficients, and scaling and offset values applied in association with the matrix coefficients for the picture resulting from the NNPF is specified in the SEI message syntax structure. nnpfc_separate_colour_description_present_flag equal to 0 indicates that the combination of colour primaries, transfer characteristics, matrix coefficients, and scaling and offset values applied in association with the matrix coefficients for the picture resulting from the NNPF is the same as indicated in VUI parameters for the CLVS.

nnpfc_colour_primaries has the same semantics as specified in subclause 7.3 for the vui_colour_primaries syntax element, except as follows:
nnpfc_colour_primaries specifies the colour_primaries of the picture resulting from applying the NNPF specified in the SEI message, rather than the colour_primaries used for the CLVS.
When nnpfc_colour_primaries is not present in the NNPFC SEI message, the value of nnpfc_colour_primaries is inferred to be equal to vui_colour_primaries.

nnpfc_transfer_characteristics has the same semantics as specified in subclause 7.3 for the vui_transfer_characteristics syntax element, except as follows:
nnpfc_transfer_characteristics specifies the transfer characteristics of the picture resulting from applying the NNPF specified in the SEI message, rather than the transfer characteristics used for the CLVS.
When nnpfc_transfer_characteristics is not present in the NNPFC SEI message, the value of nnpfc_transfer_characteristics is inferred to be equal to vui_transfer_characteristics.

nnpfc_matrix_coeffs describes the equations used in deriving luma and chroma signals from the green, blue, and red, or Y, Z, and X primaries. Its semantics apply to the pictures resulting from applying the NNPF specified in this SEI message and are as specified for MatrixCoefficients in Rec. ITU-T H.273| ISO/IEC 23091-2 with BitDepthY and BitDepthC being equal to outTensorBitDepthY and outTensorBitDepthC, respectively.

When nnpfc_matrix_coeffs is not present in the NNPFC SEI message, the value of nnpfc_matrix_coeffs is inferred to be equal to vui matrix_coeffs.

nnpfc_matrix_coeffs shall not be equal to 0 unless both of the following conditions are true:
nnpfc_out_tensor_chroma_bitdepth_minus8 is equal to nnpfc_out_tensor_luma_bitdepth_minus8.
nnpfc_out_order_idc is equal to 2, outSubHeightC is equal to 1, and outSubWidthC is equal to 1. nnpfc_matrix_coeffs shall not be equal to 8 unless one of the following conditions is true:
nnpfc_out_tensor_chroma_bitdepth_minus8 is equal to nnpfc_out_tensor_luma_bitdepth_minus8.
nnpfc_out_tensor_chroma_bitdepth_minus8 is equal to nnpfc_out_tensor_luma_bitdepth_minus8+1, nnpfc_out_order_idc is equal to 2, outSubHeightC is equal to 1, and outSubWidthC is equal to 1.

nnpfc_full_range_flag indicates the scaling and offset values applied in association with the matrix coefficients as specified by nnpfc_matrix_coeffs. Its semantics are as specified for the VideoFullRangeFlag parameter in Rec. ITU-T H.273 ISO/IEC 23091-2. When not present, the value of nnpfc_full_range_flag is inferred to be equal to 0.

nnpfc_chroma_loc_info_present_flag equal to 1 indicates the presence of the nnpfc_chroma_sample_loc type_frame syntax element in the NNPFC SEI message. nnpfc_chroma_loc_info_present_flag equal to 0 indicates the absence of the nnpfc_chroma_sample_loc type_frame syntax element in the NNPFC SEI message. When colourizationFlag is equal to 0 or nnpfc_out_colour_format_idc is not equal to 1, the value of nnpfc_chroma_loc_info_present_flag shall be equal to 0.

nnpfc_chroma_sample_loc type_frame, when not equal to 6 and nnpfc_out_colour_format_idc is equal to 1, specifies the location of chroma samples of the output pictures, as shown in FIG. 1. nnpfc_chroma_sample_loc type_frame equal to 6 and nnpfc_out_colour_format_idc equal to 1 indicates that the location of the chroma samples is unknown or unspecified or specified by other means not specified in this document. The value of nnpfc_chroma sample_loc type_frame shall be in the range of 0 to 6, inclusive.

nnpfc_overlap indicates the overlapping horizontal and vertical sample counts of adjacent input tensors of the NNPF. The value of nnpfc_overlap shall be in the range of 0 to 16 383, inclusive.

nnpfc_constant_patch_size_flag equal to 1 indicates that the NNPF accepts exactly the patch size indicated by nnpfc_patch_width_minus1 and nnpfc_patch_height_minus1 as input. nnpfc_constant_patch_size_flag equal to 0 indicates that the NNPF accepts as input any patch size with width inpPatchWidth and height inpPatchHeight such that the width of an extended_patch (i.e., a patch plus the overlapping area), which is equal to inpPatchWidth+2*nnpfc_overlap, is a positive integer multiple of nnpfc_extended_patch_width_cd_delta_minus1+1+2*nnpfc_overlap, and the height of the extended_patch, which is equal to inpPatchHeight+2*nnpfc_overlap, is a positive integer multiple of nnpfc_extended_patch_height_cd_delta_minus1+1+2*nnpfc_overlap.

nnpfc_patch_width_minus1 plus 1, when nnpfc_constant_patch_size_flag equal to 1, indicates the horizontal sample counts of the patch size required for the input to the NNPF. The value of nnpfc_patch_width_minus1 shall be in the range of 0 to Min(32 766, CroppedWidth−1), inclusive.

nnpfc_patch_height_minus1 plus 1, when nnpfc_constant_patch_size_flag equal to 1, indicates the vertical sample counts of the patch size required for the input to the NNPF. The value of nnpfc_patch_height_minus1 shall be in the range of 0 to Min(32 766, CroppedHeight−1), inclusive.

nnpfc_extended_patch_width_cd_delta_minus1 plus 1 plus 2*nnpfc_overlap, when nnpfc_constant_patch_size_flag equal to 0, indicates a common divisor of all allowed values of the width of an extended_patch required for the input to the NNPF. The value of nnpfc_extended_patch_width_cd_delta_minus1 shall be in the range of 0 to Min(32 766, CroppedWidth−1), inclusive.

nnpfc_extended_patch_height_cd_delta_minus1 plus 1 plus 2*nnpfc_overlap, when nnpfc_constant_patch_size_flag equal to 0, indicates a common divisor of all allowed values of the height of an extended patch required for the input to the NNPF. The value of nnpfc_extended_patch_height_cd_delta_minus1 shall be in the range of 0 to Min(32 766, CroppedHeight−1), inclusive.

Let the variables inpPatchWidth and inpPatchHeight be the patch size width and the patch size height, respectively.

If nnpfc_constant_patch_size_flag is equal to 0, the following applies:
The values of inpPatchWidth and inpPatchHeight are either provided by external means not specified in this document or set by the post-processor itself.
The value of inpPatchWidth+2*nnpfc_overlap shall be a positive integer multiple ofnnpfc_extended_patch_width_cd_delta_minus1+1+2*nnpfc_overlap and inpPatchWidth shall be less than or equal to CroppedWidth. The value of inpPatchHeight+2*nnpfc_overlap shall be a positive integer multiple ofnnpfc_extended_patch_height_cd_delta_minus1+1+2*nnpfc_overlap and inpPatchHeight shall be less than or equal to CroppedHeight.

Otherwise (nnpfc_constant_patch_size_flag is equal to 1), the value of inpPatchWidth is set equal to nnpfc_patch_width_minus1+1 and the value of inpPatchHeight is set equal to nnpfc_patch_height_minus1+1.

The variables outPatchWidth, outPatchHeight, horCScaling, verCScaling, outPatchCWidth, and outPatchCHeight are derived as follows:

$$outPatchWidth = ( nnpfcOutputPicWidth * inpPatchWidth ) / CroppedWidth \qquad ( 92 )$$

$$outPatchHeight = ( nnpfcOutputPicHeight * inpPatchHeight ) / CroppedHeight \qquad ( 93 )$$

$$horCScaling = SubWidthC / outSubWidthC \qquad ( 94 )$$

$$verCScaling = SubWidthC / outSubHeightC \qquad ( 95 )$$

$$outPatchCWidth = outPatchWidth * horCScaling \qquad ( 96 )$$

$$outPatchCHeight = outPatchHeight * verCScaling \qquad ( 97 )$$

It is a requirement of bitstream conformance that outPatchWidth*CroppedWidth shall be equal to nnpfcOutputPicWidth*inpPatchWidth and outPatchHeight*CroppedHeight shall be equal to nnpfcOutputPicHeight*inpPatchHeight.

nnpfc_padding type indicates the process of padding when referencing sample locations outside the boundaries of the input picture as described in Table 4. The value of nnpfc_padding type shall be in the range of 0 to 4, inclusive, in bitstreams conforming to this edition of this document. Values of 5 to 15, inclusive, for nnpfc_padding type are reserved for future use by ITU-T| ISO/IEC and shall not be present in bitstreams conforming to this edition of this document. Decoders conforming to this edition of this document shall ignore NNPFC SEI messages with nnpfc_padding type in the range of 5 to 15, inclusive. Values of nnpfc_padding type greater than 15 shall not be present in bitstreams conforming to this edition of this document and are not reserved for future use.

TABLE 4
Informative description of nnpfc_padding_type values

| nnpfc_padding_type | Description |
|---|---|
| 0 | Zero padding |
| 1 | Replication padding |
| 2 | Reflection padding |
| 3 | Wrap-around padding |
| 4 | Fixed padding |
| 5 . . . 15 | reserved |

nnpfc_luma_padding_val indicates the luma value to be used for padding when nnpfc_padding type is equal to 4. The value of nnpfc_luma_padding_val shall be in the range of 0 to (1 «BitDepthY)−1, inclusive.

nnpfc_cb_padding_val indicates the Cb value to be used for padding when nnpfc_padding type is equal to 4. The value of nnpfc_cb_padding_val shall be in the range of 0 to (1 «BitDepthC)−1, inclusive.

nnpfc_cr_padding_val indicates the Cr value to be used for padding when nnpfc_padding type is equal to 4. The value of nnpfc_cr_padding_val shall be in the range of 0 to (1 «BitDepthC)−1, inclusive.

The function InpSampleVal(y, x, picHeight, picWidth, croppedPic, cIdx) with inputs being a vertical sample location y, a horizontal sample location x, a picture height picHeight, a picture width picWidth, sample array croppedPic, and component index cIdx (equal to 0 for luma, 1 for Cb, and 2 for Cr) returns the value of sampleVal derived as follows:

NOTE 6—For the inputs to the function InpSampleVal( ), the vertical location is listed before the horizontal location for compatibility with input tensor conventions of some inference engines.

if( nnpfc_padding_type = = 0 )
if( y < 0 ∥ x < 0 ∥ y >= picHeight ∥ x >= picWidth )
sampleVal = 0
else

| | |
|---|---|
| sampleVal = croppedPic[ x ][ y ] | (98) |

```
else if( nnpfc_padding_type = = 1 )
sampleVal = croppedPic[ Clip3( 0, picWidth − 1, x ) ][ Clip3( 0, picHeight − 1, y ) ]
else if( nnpfc_padding_type = = 2 )
sampleVal = croppedPic[ Reflect( picWidth − 1, x ) ][ Reflect( picHeight − 1, y ) ]
else if( nnpfc_padding_type = = 3 )
if( y >= 0 && y < picHeight )
  sampleVal = croppedPic[ Wrap( picWidth − 1, x ) ][ y ]
else if( nnpfc_padding_type = = 4 )
if( y < 0 ∥ x < 0 ∥ y >= picHeight ∥ x >= picWidth )
  sampleVal = ( cIdx = = 0 ? nnpfc_luma_padding_val :
    ( cIdx = = 1 ? nnpfc_cb_padding_val : nnpfc_cr_padding_val ) )
else
  sampleVal = croppedPic[ x ][ y ]
```

An NNPF PostProcessingFilter( ) is the target NNPF as derived in the semantics of the NNPFA SEI message. The following example process may be used, with the NNPF PostProcessingFilter( ), to generate, in a patch-wise manner, the filtered and/or interpolated picture(s), which contain Y, Cb, and Cr sample arrays FilteredYPic, FilteredCbPic, and FilteredCrPic, respectively, as indicated by nnpfc_out_order_idc:

```
if( nnpfc_inp_order_idc = = 0 ∥ nnpfc_inp_order_idc = = 2 )
for( cTop = 0; cTop < CroppedHeight; cTop += inpPatchHeight )
  for( cLeft = 0; cLeft < CroppedWidth; cLeft += inpPatchWidth ) {
    DeriveInputTensors( )
    outputTensor = PostProcessingFilter( inputTensor )
    Store OutputTensors( )
  }
else if( nnpfc_inp_order_idc = = 1 )
for( cTop = 0; cTop < CroppedHeight / SubHeightC; cTop += inpPatchHeight )
  for( cLeft = 0; cLeft < CroppedWidth / SubWidthC; cLeft += inpPatchWidth ) {
```

(99)

```
    DeriveInputTensors( )
    outputTensor = PostProcessingFilter( inputTensor )
    StoreOutputTensors( )
  }
else if( nnpfc_inp_order_idc = = 3 )
for( cTop = 0; cTop < CroppedHeight; cTop += inpPatchHeight * 2 )
  for( cLeft = 0; cLeft < CroppedWidth; cLeft += inpPatchWidth * 2 ) {
    DeriveInputTensors( )
    outputTensor = PostProcessingFilter( inputTensor )
    StoreOutputTensors( )
  }
```

An NNPF-generated picture with index i contains sample arrays FilteredYPic[i], FilteredCbPic[i], and FilteredCrPic[i], when present, that are derived by Formula 99. An NNPF-generated picture does not include the overlap regions.

The NNPF process consists of the process defined by Formula 99 followed by outputting NNPF-generated pictures in their increasing index order, where all NNPF-generated pictures that were interpolated by the NNPF are output and those NNPF-generated pictures that correspond to any input pictures to the NNPF are output as specified in the semantics of the NNPFA SEI message.

nnpfc_complexity_info_present_flag equal to 1 specifies that one or more syntax elements that indicate the complexity of the NNPF associated with the nnpfc_id are present. nnpfc_complexity_info_present_flag equal to 0 specifies that no syntax elements that indicates the complexity of the NNPF associated with the nnpfc_id are present.

nnpfc_parameter_type_idc equal to 0 indicates that the neural network uses only integer parameters. nnpfc_parameter_type_flag equal to 1 indicates that the neural network may use floating point or integer parameters. nnpfc_parameter_type_idc equal to 2 indicates that the neural network uses only binary parameters. nnpfc_parameter_type_idc equal to 3 is reserved for future use by ITU-T| ISO/IEC and shall not be present in bitstreams conforming to this edition of this document. Decoders conforming to this edition of this document shall ignore NNPFC SEI messages with nnpfc_parameter_type_idc equal to 3.

nnpfc_log 2_parameter_bit_length_minus3 equal to 0, 1, 2, and 3 indicates that the neural network does not use parameters of bit_length greater than 8, 16, 32, and 64, respectively. When nnpfc_parameter_type_idc is present and nnpfc_log 2_parameter_bit_length_minus3 is not present, the neural network does not use parameters of bit_length greater than 1.

nnpfc_num_parameters_idc indicates the maximum number of neural network parameters for the NNPF in units of a power of 2 048. nnpfc_num_parameters_idc equal to 0 indicates that the maximum number of neural network parameters is unknown. The value nnpfc_num_parameters_idc shall be in the range of 0 to 52, inclusive. Values of nnpfc_num_parameters_idc greater than 52 are reserved for future use by ITU-T| ISO/IEC and shall not be present in bitstreams conforming to this edition of this document. Decoders conforming to this edition of this document shall ignore NNPFC SEI messages with nnpfc_num_parameters_idc greater than 52.

If the value of nnpfc_num_parameters_idc is greater than zero, the variable maxNumParameters is derived as follows:

$$maxNumParameters = ( 2 \; 048 << nnpfc\_num\_parameters\_idc ) - 1 \qquad ( 100 )$$

It is a requirement of bitstream conformance that the number of neural network parameters of the NNPF shall be less than or equal to maxNumParameters.

nnpfc_num_kmac_operations_idc greater than 0 indicates that the maximum number of multiply-accumulate operations per sample of the NNPF is less than or equal to nnpfc_num_kmac_operations_idc*1000. nnpfc_num_kmac_operations_idc equal to 0 indicates that the maximum number of multiply-accumulate operations of the network is unknown. The value of nnpfc_num_kmac_operations_idc shall be in the range of 0 to 232-2, inclusive.

nnpfc_total_kilobyte_size greater than 0 indicates a total size in kilobytes required to store the uncompressed parameters for the neural network. The total size in bits is a number equal to or greater than the sum of bits used to store each parameter. nnpfc_total_kilobyte_size is the total size in bits divided by 8 000, rounded up. nnpfc_total_kilobyte_size equal to 0 indicates that the total size required to store the parameters for the neural network is unknown. The value of nnpfc_total_kilobyte_size shall be in the range of 0 to 2³²−2, inclusive.

nnpfc_metadata_extension_num_bits equal to 0 specifies that nnpfc_reserved_metadata_extension is not present. nnpfc_metadata_extension_num bits greater than 0 specifies the length, in bits, of nnpfc_reserved_metadata_extension. nnpfc_metadata_extension_num_bits shall be equal to 0 in this edition of this document. Values in the range of 1 to 2048, inclusive, for nnpfc_metadata_extension_num_bits are reserved for future use by ITU-T| ISO/JEC and shall not be present in bitstreams conforming to this edition of this document. Decoders conforming to this edition of this document shall allow any value of nnpfc_metadata_extension_num_bits in the range of 0 to 2048, inclusive. Values of nnpfc_metadata_extension_num bits greater than 2048 shall not be present in bitstreams conforming to this edition of this document and are not reserved for future use.

nnpfc_reserved_metadata_extension shall not be present in bitstreams conforming to this edition of this document. However, decoders conforming to this edition of this document shall ignore the presence and value ofnnpfc_reserved_metadata_extension. When present, the length, in bits, ofnnpfc_reserved_metadata_extension is equal to nnpfc_metadata_extension_num_bits.

nnpfc_reserved_zero_bit_b shall be equal to 0 in bitstreams conforming to this edition of this document. Decoders shall ignore NNPFC SEI messages in which nnpfc_reserved_zero_bit_b is not equal to 0.

nnpfc_payload_byte[i] contains the i-th byte of a bitstream conforming to ISO/JEC 15938-17. The byte sequence nnpfc_payload_byte[i] for all present values of i shall be a complete bitstream that conforms to ISO/IEC 15938-17.

### 8.28.3 Neural-Network Post-Filter Activation SEI Message

### 8.28.3.1 Neural-Network Post-Filter Activation SEI Message Syntax

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) { | |
| nnpfa_target_base_flag | u(1) |
| nnpfa_persistence_flag | u(1) |
| nnpfa_num_output_entries | ue(v) |
| for( i = 0; i < nnpfa_num_output_entries; i++ ) | |
| nnpfa_output_flag[ i ] | u(1) |
| } | |
| } | |

### 8.23.3.2 Neural-Network Post-Filter Activation SEI Message Semantics

The neural-network post-filter activation (NNPFA) SEI message activates or de-activates the possible use of the target neural-network post-processing filter (NNPF), identified by nnpfa_target_id and nnpfa_target_base_flag, for post-processing filtering of a set of pictures. For a particular picture for which the NNPF is activated, the target NNPF is derived as follows:
If nnpfa_target_base_flag is equal to 1, the target NNPF is the base NNPF with nnpfc_id equal to nnpfa_target_id.
Otherwise (nnpfa_target_base_flag is equal to 0), the target NNPF is the NNPF specified by the last NNPFC SEI message with nnpfc_id equal to nnpfa_target_id that precedes the first VCL NAL unit of the current picture in decoding order and is not a repetition of the NNPFC SEI message that contains the base NNPF.

NOTE—There can be several NNPFA SEI messages present for the same picture, for example, when the NNPFs are meant for different purposes or for filtering of different colour components.

nnpfa_target_id indicates the target NNPF, which is specified by one or more NNPFC SEI messages that pertain to the current picture and have nnpfc_id equal to nnpfa_target_id. The value of nnpfa_target_id shall be in the range of 0 to 232-2, inclusive.

An NNPFA SEI message with a particular value of nnpfa_target_id shall not be present in a current PU unless one or both of the following conditions are true:
Within the current CLVS there is an NNPFC SEI message with nnpfc_id equal to the particular value of nnpfa_target_id present in a PU preceding the current PU in decoding order.
There is an NNPFC SEI message with nnpfc_id equal to the particular value of nnpfa_target_id in the current PU.

When a PU contains both an NNPFC SEI message with a particular value of nnpfc_id and an NNPFA SEI message with nnpfa_target_id equal to the particular value of nnpfc_id, the NNPFC SEI message shall precede the NNPFA SEI message in decoding order.

nnpfa_cancel_flag equal to 1 indicates that the persistence of the target NNPF established by any previous NNPFA SEI message with the same nnpfa_target_id as the current SEI message is cancelled, i.e., the target NNPF is no longer used unless it is activated by another NNPFA SEI message with the same nnpfa_target_id as the current SEI message and nnpfa_cancel_flag equal to 0. nnpfa_cancel_flag equal to 0 indicates that the nnpfa_target_base_flag, nnpfa_persistence_flag, and nnpfa_num_output_entries follow.

nnpfa_target_base_flag equal to 1 specifies that the target NNPF is the base NNPF with nnpfc_id equal to nnpfa_target_id. nnpfa_target_base_flag equal to 0 specifies that the target NNPF is the NNPF specified by the last NNPFC SEI message with nnpfc_id equal to nnpfa_target_id that precedes the first VCL NAL unit of the current picture in decoding order and is not a repetition of the NNPFC SEI message that contains the base NNPF.

nnpfa_persistence_flag specifies the persistence of the target NNPF for the current layer.

nnpfa_persistence_flag equal to 0 specifies that the target NNPF may be used for post-processing filtering for the current picture only.

nnpfa_persistence_flag equal to 1 specifies that the target NNPF may be used for post-processing filtering for the current picture and all subsequent pictures of the current layer in output order until one or more of the following conditions are true:
A new CLVS of the current layer begins.
The bitstream ends.
A picture in the current layer associated with a NNPFA SEI message with the same nnpfa_target_id as the current SEI message and nnpfa_cancel_flag equal to 1 is output that follows the current picture in output order.

NOTE—The target NNPF is not applied for this subsequent picture in the current layer associated with a NNPFA SEI message with the same nnpfa_target_id as the current SEI message and nnpfa_cancel_flag equal to 1.

Let the nnpfcTargetPictures be the set of pictures to which the last NNPFC SEI message with nnpfc_id equal to nnpfa_target_id that precedes the current NNPFA SEI message in decoding order pertains. Let nnpfaTargetPictures be the set of pictures for which the target NNPF is activated by the current NNPFA SEI message. It is a requirement of bitstream conformance that any picture included in nnpfaTargetPictures shall also be included in nnpfcTargetPictures.

nnpfa_num_output_entries specifies the number of nnpfa_output_flag[i] syntax elements present in the NNPFA SEI message. The value of nnpfa_num_output_entries shall be in the range of 0 to NumInpPicsInOutputTensor, inclusive.

nnpfa_output_flag[i] equal to 1 specifies that the NNPF-generated picture that corresponds to the input picture having index InpIdx[i] is output by the NNPF process activated by this NNPFA SEI message, where the NNPF process is specified in the semantics of the NNPFC SEI message. nnpfa_output_flag[i] equal to 0 specifies that the NNPF-generated picture that corresponds to the input picture having index InpIdx[i] is not output by the NNPF process activated by this NNPFA SEI message. When nnpfa_num_output_entries is less than NumInpPicsInOutputTensor, nnpfa_output_flag[i] is inferred to be equal to 1 for each value of i in the range of nnpfa_num_output_entries to NumInpPicsInOutputTensor−1, inclusive.

D.12.11 Use of the neural network post-filter characteristics SEI message.

Let currPic be the cropped decoded output picture for which the neural-network post-processing filter (NNPF) defined by the neural-network post-filter characteristics (NNPFC) SEI message is activated by a neural-network post-filter activation (NNPFA) SEI message and currLayerld be the nuh_layer_id value of currPic.

It is a requirement of bitstream conformance that when a picture unit contains an NNPFA SEI message, the value of ph_pic_output_flag in the picture header contained in that picture unit shall be equal to 1.

NOTE—Since only cropped decoded output pictures are used as input pictures of the NNPF, the value of ph_pic_output_flag in the picture header of the coded picture corresponding to each input picture of the NNPF is equal to 1.

The variable pictureRateUpsamplingFlag is set equal to (nnpfc_purpose & 0x08) !=0.

The variable numInputPics is set equal to nnpfc_num_input_pics_minus1+1.

The variable numInferences is derived as follows:
If pictureRateUpsamplingFlag is equal to 1, the NNPFA SEI message that activated this NNPF has nnpfa_persistence_flag equal to 1, nnpfc_interpolated_pics[i] is greater than 0 only for a single value of i that is greater than 0, and currPic is the last picture of the bitstream in output order that has nuh_layer_id equal to currLayerld, the variable numPostRoll is set equal to the value of i such that nnpfc_interpolated_pics[i] is greater than 0 and the variable numInferences is set equal to 1+numPostRoll.
Otherwise, the variable numInferences is set equal to 1.

For each value of j in the range of 0 to numInferences−1, inclusive, the following applies:
The arrays inputPic[i] and inputPresentFlag[i] for i in the range of 0 to numInputPics−1, inclusive, representing all the input pictures and the presence of input pictures within the bitstream, respectively, are specified as follows:
   When j is greater than 0, for each value of k in the range of 0 to j−1, inclusive, inputPic[k] is set to be currPic and inputPresentFlag[k] is set equal to 0.
   The j-th input picture, inputPic[j], is set equal to be currPic and inputPresentFlag[j] is set equal to 1.
   When numInputPics is greater than 1, the following applies for each value of i in the range ofj+1 to numInputPics−j−1, inclusive, in increasing order of i:
      If pictureRateUpsamplingFlag is equal to 1, currPic is associated with a frame packing arrangement SEI message with fp_arrangement_type equal to 5 and a particular value of fp_current_frame_is_frame0_flag, and there is a cropped decoded output picture prevPic that is the last picture in output order among all cropped decoded output pictures that have nuh_layer_id equal to currLayerld, precede inputPic[i−1] in output order, and are associated with a frame packing arrangement SEI message with fp_arrangement_type equal to 5 and the same value of fp_current_frame_is_frame0_flag, inputPic[i] is set to be prevPic and inputPresentFlag[i] is set equal to 1.
      Otherwise, if pictureRateUpsamplingFlag is equal to 0 and there is a picture prevPic that is the last picture in output order among all cropped decoded output pictures that have nuh_layer_id equal to currLayerld and precede inputPic[i−1] in output order, inputPic[i] is set to be prevPic and inputPresentFlag[i] is set equal to 1.
      Otherwise, if currPic is not associated with a frame packing arrangement SEI message with fp_arrangement_type equal to 5 and there is a cropped decoded output picture prevPic that is the last picture in output order among all cropped decoded output pictures that have nuh_layer_id equal to currLayerld and precede inputPic[i−1] in output order, inputPic[i] is set to be prevPic and inputPresentFlag[i] is set equal to 1.
      Otherwise, the following applies:
         inputPic[i] is set to be the same picture as inputPic[i−1] and inputPresentFlag[i] is set equal to 0.
         It is a requirement of bitstream conformance that num_interpolated_pics[i−1] shall not be greater than 0.
For purposes of interpretation of the NNPFC SEI message, the following variables are specified:
   If numInputPics is greater than 1 and there is a second NNPF that is defined by at least one NNPFC SEI message, is activated by an NNPFA SEI message for currPic, and has nnpfc_purpose equal to 4, the following applies:
      CroppedWidth is set equal to nnpfc_pic_width_in_luma_samples defined for the second NNPF.
      CroppedHeight is set equal to nnpfc_pic_height_in_luma_samples defined for the second NNPF.
   Otherwise, the following applies:
      CroppedWidth is set equal to the value of pps_pic_width_in_luma_samples−SubWidthC*(pps_conf_win_left_offset+pps_conf_win_right_offset) for currPic.
      CroppedHeight is set equal to the value of pps_pic_height_in_luma_samples−SubHeightC*(pps_conf_win_top_offset+pps_conf_win_bottom_offset) for currPic.
   The luma sample arrays CroppedYPic[i] and the chroma sample arrays CroppedCbPic[i] and CroppedCrPic[i], when present, are derived as follows for each value of i in the range of 0 to numInputPics−1, inclusive:
      The variable sourcePic is derived as follows:
         If inputPresentFlag[i] is equal to 1 or nnpfc_absent_input_pic_zero_flag is equal to 0, sourcePic is set to be inputPic[i].
         Otherwise(inputPresentFlag[i] is equal to 0 and nnpfc_absent_input_pic_zero_flag is equal to 1), sourcePic is set to be a picture with a luma sample array of CroppedWidth×CroppedHeight samples equal to 0 and Cb and Cr sample arrays of (CroppedWidth/SubWidthC)×(CroppedHeight/SubHeightC) samples equal to 0.
   If numInputPics is equal to 1, the following applies:
      The luma sample array CroppedYPic[i] and the chroma sample arrays CroppedCbPic[i] and CroppedCrPic[i], when present, are set to be the 2-dimensional arrays of decoded sample values of the Y, Cb and Cr components, respectively, of sourcePic.
   Otherwise (numInputPics is greater than 1), the following applies:
      The variable sourceWidth is set equal to the value of pps_pic_width_in_luma_samples−SubWidthC*(pps_conf_win_left_offset+pps_conf_win_right_offset) for sourcePic.
      The variable sourceHeight is set equal to the value of pps_pic_height_in_luma_samples−SubHeightC*(pps_conf_win_top_offset+pps_conf_win_bottom_offset) for sourcePic.
      If sourceWidth is equal to CroppedWidth and sourceHeight is equal to CroppedHeight, inputPic is set to be the same as sourcePic.
      Otherwise (sourceWidth is not equal to CroppedWidth or sourceHeight is not equal to CroppedHeight), the following applies:
         There shall be an NNPF, hereafter referred to as the super resolution NNPF, that is defined by at least one NNPFC SEI message, is activated by an NNPFA SEI message for sourcePic, and has nnpfc_purpose equal to 4, nnpfc_pic_width_in_luma_samples equal to CroppedWidth and nnpfc_pic_height_in_luma_samples equal to CroppedHeight.
         resampledPic is set to be the output of the neural-network inference of the super resolution NNPF with sourcePic being an input.
      The luma sample array CroppedYPic[i] and the chroma sample arrays CroppedCbPic[i] and CroppedCrPic[i], when present, are set to be the 2-dimensional arrays of decoded sample values of the Y, Cb and Cr components, respectively, of resampledPic.
BitDepthy and BitDepthc are both set equal to BitDepth.
ChromaFormatIdc is set equal to sps_chroma_format_idc.
The array StrengthControlVal[i] for all values of i in the range of 0 to numInputPics−1, inclusive, specifying the filtering strength control value for the input pictures for the NNPF, is derived as follows:
   StrengthControlVal[i] is set equal to the value of (firstSliceQpy+QpBdOffset)−(63+QpBdOffset), where firstSliceQpy is equal to SliceQpy of the first slice of inputPic[i].

There shall not be more than two NNPFC SEI messages present in a picture unit with the same value of nnpfc_id. When there are two NNPFC SEI messages present in a picture unit with the same value of nnpfc_id, these SEI messages shall have different content. When two NNPFC SEI messages with the same nnpfc_id and different content are present in the same picture unit, both of these NNPFC SEI messages shall be in the same SEI NAL unit.

### 4. Technical Problems Solved by Disclosed Technical Solutions

The current design for the neural-network post-filter characteristics (NNPFC) SEI message has the following problems:

A syntax element with a name ending with “_idc” is also referred to as an indicator syntax element. Some indicator syntax elements are ue(v)-coded, such as nnpfc_inp_format_idc, nnpfc_out_format_idc, nnpfc_mode_idc, nnpfc_inp_order_idc, nnpfc_out_order_idc, and/or nnpfc_auxiliary_inp_idc. However, to save bitrates, it might be desirable to decrease the maximum value of these syntax elements and use u(N)-coded syntax elements, where N is an integer greater than 0, instead of ue(v)-coded syntax elements. In addition, since the number of possible values for each of these indicator syntax elements is very limited, e.g., for some of them not more than four, it might be desirable to simply code one or more of these indicator syntax elements with fixed-length coding, i.e., u(N)-coded, where N is an integer greater than 0, instead of coding them as ue(v)-coded syntax elements.

### 5. a Listing of Solutions and Embodiments

To solve the above-described problems, methods as summarized below are disclosed. The embodiments should be considered as examples to explain the general concepts and should not be interpreted in a narrow way. Furthermore, these embodiments can be applied individually or combined in any manner.
1) To solve problem 2, instead of ue(v)-coded syntax elements or using ue(v)-coding, some or all of the following syntax elements: nnpfc_inp_format_idc, nnpfc_out_format_idc, nnpfc_mode_idc, nnpfc_inp_order_idc, nnpfc_out_order_idc, and nnpfc_auxiliary_inp_idc may be coded as u(N)-coded syntax elements where N is an integer greater than 0.
   a. In one example, for one or more of these syntax elements, the value of N is equal to 2, 3, or 4.
   b. In one example, different syntax elements may use different values for N.
      i. In one example, nnpfc_inp_format_idc and nnpfc_out_format_idc may be coded as u(3)-coded syntax elements while nnpfc_mode_idc, nnpfc_inp_order_idc, nnpfc_out_order_idc, and nnpfc_auxiliary_inp_idc may be coded as u(4)-coded syntax elements.
   c. In one example, nnpfc_mode_idc is coded as u(N)-coded syntax element, instead of ue(v)-coded syntax element. Consequently, the value of nnpfc_mode_idc is in the range of 0 to 2^{N}−1, inclusive.
   d. In one example, nnpfc_inp_format_idc is coded as u(N)-coded syntax element, instead of ue(v)-coded syntax element. Consequently, the value of nnpfc_inp_format_idc is in the range of 0 to 2^{N}−1, inclusive.
   e. In one example, nnpfc_inp_order_idc is coded as u(N)-coded syntax element, instead of ue(v)-coded syntax element. Consequently, the value of nnpfc_inp_order_idc is in the range of 0 to 2^{N}−1, inclusive.
   f. In one example, nnpfc_auxiliary_inp_idc is coded as u(N)-coded syntax element, instead of ue(v)-coded syntax element. Consquently, the value of nnpfc_auxiliary_inp_idc is in the range of 0 to 2^{N}−1, inclusive.
   g. In one example, nnpfc_out_format_idc is coded as u(N)-coded syntax element, instead of ue(v)-coded syntax element. Consequently, the value of nnpfc_out_format_idc is in the range of 0 to 2^{N}−1, inclusive.
   h. In one example, nnpfc_out_order_idc is coded as u(N)-coded syntax element, instead of ue(v)-coded syntax element. Consquently, the value of nnpfc_out_order_idc is in the range of 0 to 2^{N}−1, inclusive.
   i. In one example, any combination of above-mentioned syntax elements could be coded as u(N)-coded syntax elements, instead of ue(v)-coded syntax elements.
   j. In one example, all the above-mentioned syntax elements are coded as u(N)-coded syntax elements, instead of ue(v)-coded syntax elements.

### 6. Embodiments

Below are some example embodiments for the invention aspects summarized above in Section 5.

Most relevant parts that have been added or modified are indicated with double braces {{ }}, and some of the deleted parts are indicated with triple brackets[[[ ]]]. There may be some other changes that are editorial in nature and thus not indicated.

### 6.1 Embodiment 1

This embodiment is for items 1, 2, and all their subitems, summarized above in Section 5.

### 8.28.1 Neural-Network Post-Filter Characteristics SEI Message Syntax

| | Descriptor |
|---|---|
| nn_post_filter_characteristics( payloadSize ) { | |
| ... | |
| {{nnpfc_inp_format idc}} | [[[ue(v)]]] |
| | {{u(3)}} |
| {{nnpfc_auxiliary_inp_idc}} | ue(v) |
| {{nnpfc_inp_order_idc}} | ue(v) |
| if( nnpfc_inp_format_idc = = 1 ) { | |
| if( nnpfc_inp_order_idc != 1 ) | |
| {{nnpfc_inp_tensor_luma_bitdepth_minus8}} | ue(v) |
| if( nnpfc_inp_order_idc != 0 ) | |
| {{nnpfc_inp_tensor_chroma_bitdepth_minus8}} | ue(v) |
| } | |
| {{nnpfc_out_format_idc}} | [[[ue(v)]]] |
| | {{u(3)}} |
| {{nnpfc_out_order_idc}} | ue(v) |
| ... | |
| } | |

### 8.28.2 Neural-Network Post-Filter Characteristics SEI Message Semantics

{{nnpfc_inp_format_idc}}indicates the method of converting a sample value of the input picture to an input value to the NNPF. {{The value of nnpfc_inp_format_idc shall be in the range of 0 to 7, inclusive. Values of 2 to 7, inclusive, for nnpfc_inp_format_idc are reserved for future use by ITU-T| ISO/IEC and shall not be present in bitstreams conforming to this edition of this document. Decoders conforming to this edition of this document shall ignore NNPFC SEI messages with nnpfc_inp_format_idc greater than 1.}}

When nnpfc_inp_format_idc is equal to 0, the input values to the NNPF are real numbers and the functions InpY( ) and InpC( ) are specified as follows:

$$InpY ( x ) = x \div ( ( 1 << {BitDepth}_{Y} ) - 1 ) \qquad ( 81 )$$

$$InpC ( x ) = x \div ( ( 1 << {BitDepth}_{C} ) - 1 ) \qquad ( 82 )$$

When nnpfc_inp_format_idc is equal to 1, the input values to the NNPF are unsigned integer numbers and the functions InpY( ) and InpC( ) are specified as follows:

shiftY = BitDepth_{Y} − inpTensorBitDepth_{Y}
if( inpTensorBitDepth_{Y} >= BitDepth_{Y})

| | |
|---|---|
| InpY( x ) = x << ( inpTensorBitDepth_{Y} − BitDepth_{Y} ) | (83) |

else
InpY( x ) = Clip3(0, ( 1 << inpTensorBitDepth_{Y} ) − 1, ( x + ( 1 << (
shiftY − 1 ) ) ) >> shiftY )
shiftC = BitDepth_{C} − inpTensorBitDepth_{C}
if( inpTensorBitDepth_{C} >= BitDepth_{C} )

| | |
|---|---|
| InpC( x ) = x << ( inpTensorBitDepth_{C} − BitDepth_{C} ) | (84) |

else
InpC( x ) = Clip3(0, ( 1 << inpTensorBitDepth_{C} ) − 1, ( x + ( 1 << (
shiftC − 1 ) ) ) >> shiftC )

The variable inpTensorBitDepthy is derived from the syntax element nnpfc_inp_tensor_luma_bitdepth_minus8 as specified below. The variable inpTensorBitDepthc is derived from the syntax element nnpfc_inp_tensor_chroma_bitdepth_minus8 as specified below.

[[[Values of nnpfc_inp_format_idc greater than 1 are reserved for future specification by ITU-T ISO/IEC and shall not be present in bitstreams conforming to this edition of this document. Decoders conforming to this edition of this document shall ignore NNPFC SEI messages that contain reserved values of nnpfc_inp_format_idc.]]]

{{nnpfc_out_format_idc}}equal to 0 indicates that the sample values output by the NNPF are real numbers where the value range of 0 to 1, inclusive, maps linearly to the unsigned integer value range of 0 to (1 «bitDepth)−1, inclusive, for any desired bit depth bitDepth for subsequent post-processing or displaying.

nnpfc_out_format_idc equal to 1 indicates that the luma sample values output by the NNPF are unsigned integer numbers in the range of 0 to (1 «outTensorBitDepthy)−1, inclusive, and the chroma sample values output by the NNPF are unsigned integer numbers in the range of 0 to (1 «outTensorBitDepthc)−1, inclusive.

{{The value of nnpfc_out_format_idc shall be in the range of 0 to 7, inclusive. Values of 2 to 7, inclusive, for}} [[[Values of]]] nnpfc_out_format_idc [[[greater than 1]]] are reserved for future [[[specification]]]{{use}} by ITU-T| ISO/JEC and shall not be present in bitstreams conforming to this edition of this document. Decoders conforming to this edition of this document shall ignore NNPFC SEI messages {{with}}[[[that contain reserved values of]]] nnpfc_out_format_idc {{greaterthan 1}}.

### 6.2 Embodiment 2

This embodiment is for items 2, and all their subitems, summarized above in Section 5.

### 8.28.1 Neural-Network Post-Filter Characteristics SEI Message Syntax

| | Descriptor |
|---|---|
| nn_post_filter_characteristics( payloadSize ) { | |
| ... | |
| {{nnpfc_mode_idc}} | [[]ue(v)]]] |
| | {{u(3)}} |
| ... | |
| {{nnpfc_inp_format_idc}} | ue(v) |
| {{nnpfc_auxiliary_inp_idc}} | [[[ue(v)]]] |
| | {{u(4)}} |
| {{nnpfc_inp_order_idc}} | [[[ue(v)]]] |
| | {{u(4)}} |
| if( nnpfc_inp_format_idc = = 1 ) { | |
| if( nnpfc_inp_order_idc != 1 ) | |
| {{nnpfc_inp_tensor_luma_bitdepth_minus8}} | ue(v) |
| if( nnpfc_inp_order_idc != 0 ) | |
| {{nnpfc_inp_tensor_chroma_bitdepth_minus8}} | ue(v) |
| } | |
| {{nnpfc_out_format_idc}} | ue(v) |
| {{nnpfc_out_order_idc}} | [[[ue(v)]]] |
| | {{u(4)}} |
| ... | |
| } | |

### 8.28.2 Neural-Network Post-Filter Characteristics SEI Message Semantics

{{nnpfc_mode_idc}}equal to 0 indicates that this SEI message contains an ISO/IEC 15938-17 bitstream that specifies a base NNPF (when nnpfc_base_flag is equal to 1) or is an update relative to the base NNPF with the same nnpfc_id value (when nnpfc_base_flag is equal to 0).

When nnpfc_base_flag is equal to 1, nnpfc_mode_idc equal to 1 specifies that the base NNPF associated with the nnpfc_id value is a neural network identified by the URI indicated by nnpfc_uri with the format identified by the tag URI nnpfc_tag_uri.

When nnpfc_base_flag is equal to 0, nnpfc_mode_idc equal to 1 specifies that an update relative to the base NNPF with the same nnpfc_id value is defined by the URI indicated by nnpfc_uri with the format identified by the tag URI nnpfc_tag_uri.

The value of nnpfc_mode_idc shall be in the range of 0 to 1, inclusive, in bitstreams conforming to this edition of this document. Values of 2 to 255 7, inclusive, for nnpfc_mode_idc are reserved for future use by ITU-T| ISO/JEC and shall not be present in bitstreams conforming to this edition of this document. Decoders conforming to this edition of this document shall ignore NNPFC SEI messages with nnpfc_mode_idc in the range of 2 to [[[255]]]{{7}}, inclusive. [[[Values of nnpfc_mode_idc greater than 255 7 shall not be present in bitstreams conforming to this edition of this document and are not reserved for future use.]]]

{{nnpfc_auxiliary_inp_idc}}greater than 0 indicates that auxiliary input data is present in the input tensor of the NNPF. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 85.

The value of nnpfc_auxiliary_inp_idc shall be in the range of 0 to 1, inclusive, in bitstreams conforming to this edition of this document. Values of 2 to 255 15, inclusive, for nnpfc_auxiliary_inp_idc are reserved for future use by ITU-T| ISO/JEC and shall not be present in bitstreams conforming to this edition of this document. Decoders conforming to this edition of this document shall ignore NNPFC SEI messages with nnpfc_auxiliary_inp_idc in the range of 2 to 255 15, inclusive. [[[Values of nnpfc_auxiliary_inp_idc greater than 255 15 shall not be present in bitstreams conforming to this edition of this document and are not reserved for future use.]]]

{{nnpfc_inp_order_idc}}indicates the method of ordering the sample arrays of an input picture to form an input tensor to the NNPF.

The value of nnpfc_inp_order_idc shall be in the range of 0 to 3, inclusive, in bitstreams conforming to this edition of this document. Values of 4 to 255 15, inclusive, for nnpfc_inp_order_idc are reserved for future use by ITU-T IfSOJEC and shall not be present in bitstreams conforming to this edition of this document. Decoders conforming to this edition of this document shall ignore NNPFC SF1 messages with nnpfc_inporder_idc in the range of 4 to [[[255]]]{{15}}, inclusive. [[[Values of nnpfc_inp_order_idc greater than 255 15 shall not be present in bitstreams conforming to this edition ofthis documentand are not reserved for future use.]]]

When ChromaFormatdc is not equal to 1, nnpfc_inp_order_idc shall not be equal to 3.

When ChromaFormatedc is equal to 0, nnpfc_inp_order_idc shall be equal to 0.

When chromaUpsamplingFlag is equal to 1, nnpfc_inp_order_idc shall not be equal to 0.

TABLE 2
contains an informative description of
nnpfc_inp_order_idc values.

| {{nnpfc_inp | |
|---|---|
| order_idc}} | Description |
| 0 | If nnpfc_auxiliary_inp_idc is equal to 0, one luma matrix |
| | is present in the input tensor for each input picture, |
| | and the number of channels is 1. Otherwise, when |
| | nnpfc_auxiliary_inp_idc is equal to 1, one luma |
| | matrix and one auxiliary input matrix are present, and |
| | the number of channels is 2. |
| 1 | If nnpfc_auxiliary_inp_idc is equal to 0, two chroma |
| | matrices are present in the input tensor, and the number of |
| | channels is 2. Otherwise, when nnpfc_auxiliary_inp_idc |
| | is equal to 1, two chroma matrices and one auxiliary |
| | input matrix are present, and the number of channels is 3. |
| 2 | If nnpfc_auxiliary_inp_idc is equal to 0, one luma and |
| | two chroma matrices are present in the input tensor, and |
| | the number of channels is 3. Otherwise, when |
| | nnpfc_auxiliary_inp_idc is equal to 1, one luma matrix, |
| | two chroma matrices and one auxiliary input matrix are |
| | present, and the number of channels is 4. |
| 3 | If nnpfc_auxiliary_inp_idc is equal to 0, four luma |
| | matrices and two chroma matrices are present in the |
| | input tensor, and the number of channels is 6. |
| | Otherwise, when nnpfc_auxiliary_inp_idc is equal to |
| | 1, four luma matrices, two chroma matrices, and one |
| | auxiliary input matrix are present in the input tensor, |
| | and the number of channels is 7. The luma channels are |
| | derived in an interleaved manner as illustrated in |
| | FIG. 12. This nnpfc_inp_order_idc can only be used |
| | when the input chroma format is 4:2:0. |
| 4 . . . 255 15 | Reserved |

{{nnpfc_out_order_idc}}indicates the output order of samples resulting from the NNPF.

The value of nnpfc_out_order_idc shall be in the range of 0 to 3, inclusive, in bitstreams conforming to this edition of this document. Values of 4 to [[[255]]]{{15}}, inclusive, for nnpfc_out_order_idc are reserved for future use by ITU-T| ISO/IEC and shall not be present in bitstreams conforming to this edition of this document. Decoders conforming to this edition of this document shall ignore NNPFC SEI messages with nnpfc_out_order_idc in the range of 4 to 255 15, inclusive. [[[Values of nnpfc_out_order_idc greater than 255 15 shall not be present in bitstreams conforming to this edition of this document and are not reserved for future use.]]]

When chromaUpsamplingFlag is equal to 1, nnpfc_out_order_idc shall not be equal to 0 or 3.

When colourizationFlag is equal to 1, nnpfc_out_order_idc shall not be equal to 0.

TABLE 3
contains an informative description of
nnpfc_out_order_idc values.

| {{nnpfc_out | |
|---|---|
| order_idc}} | Description |
| 0 | Only the luma matrix is present in the output tensor, thus |
| | the number of channels is 1. |
| 1 | Only the chroma matrices are present in the output tensor, |
| | thus the number of channels is 2. |
| 2 | The luma and chroma matrices are present in the output |
| | tensor, thus the number of channels is 3. |
| 3 | Four luma matrices and two chroma matrices are present |
| | in the output tensor, thus the number of channels is 6. |
| | This nnpfc_out_order_idc can only be used when the |
| | output chroma format is 4:2:0. |
| 4 . . . 255 15 | Reserved |

### 7. References

[1] ITU-T and ISO/IEC, “High efficiency video coding,” Rec. ITU-T H.265 ISO/IEC 23008-2 (in force edition).
[2] J. Chen, E. Alshina, G. J. Sullivan, J.-R. Ohm, J. Boyce, “Algorithm description of Joint Exploration Test Model 7 (JEM7),” JVET-G1001, August 2017.
[3] Rec. ITU-T H.266| ISO/IEC 23090-3, “Versatile Video Coding,” 2022.
[4] Rec. ITU-T Rec. H.274 I ISO/IEC 23002-7, “Versatile Supplemental Enhancement Information Messages for Coded Video Bitstreams,” 2022.
[5] S. McCarthy, S. Deshpande, M. Hannuksela, Hendry, G. Sullivan, and Y.-K. Wang (editors), “Improvements under consideration for neural network post filter SEI messages,” JVET output document JVET-AC2032, publicly available online herein: https://jvet-experts.org/doc_end_user/current_document.php?id=12585.
[6] E. Frangois, B. Bross, M. M. Hannuksela, A. Tourapis, and Y.-K. Wang (editors), “New level and systems-related supplemental enhancement information for VVC (Draft 5)”, JVET output document JVET-AD2005, publicly available online herein: https://www.jvet-experts.org/doc_end_user/current_document .php?id=12975.

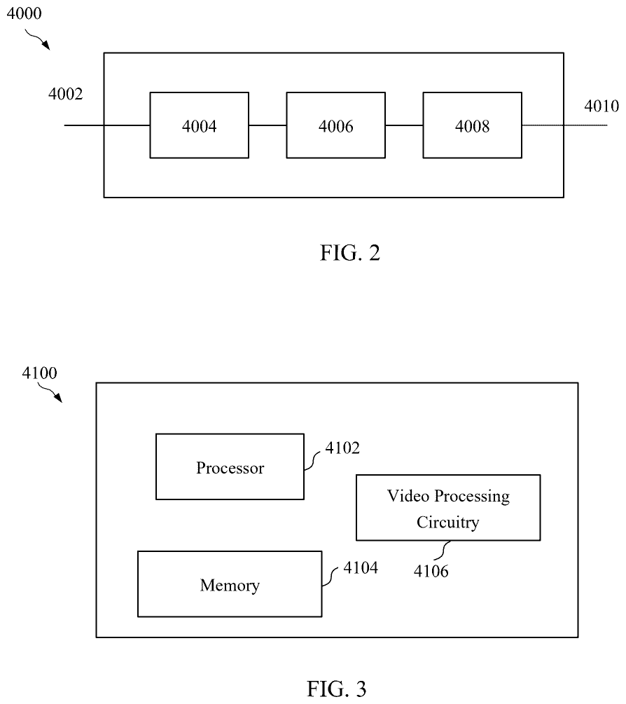

FIG. 2 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present disclosure may be embodied in various electronic devices such as mobile phones, laptops, smartphones or other devices that are capable of performing digital data processing and/or video display.

FIG. 3 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and techniques described herein. The video processing circuitry 4106 may be used to implement, in hardware circuitry, some techniques described in the present disclosure. In some embodiments, the video processing circuitry 4106 may be at least partly included in the processor 4102, e.g., a graphics co-processor.

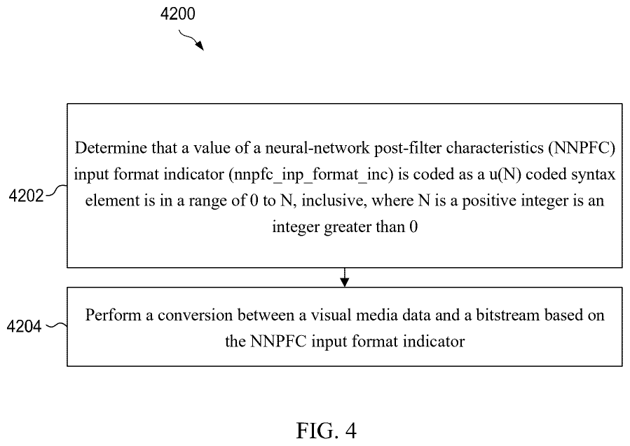

FIG. 4 is a flowchart for an example method 4200 of video processing in accordance with an embodiment of the disclosure. The method 4200 may be performed by a coding device (e.g., encoder, decoder, etc.) configured to apply an NNPF to a video or portions thereof. That is, the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200. The method 4200 may be applied during a coding process where the coding device is applying one or more filters to a video or portions thereof.

In block 4202, the coding device determines that a value of a neural-network post-filter characteristics (NNPFC) input format indicator (nnpfc_inp_format_inc) is coded as a u(N) coded syntax element where N is an integer greater than 0.

In block 4204, the coding device performs a conversion between a visual media data and a bitstream based on the NNPFC input format indicator. The conversion may include encoding at an encoder, decoding at a decoder, or combinations thereof.

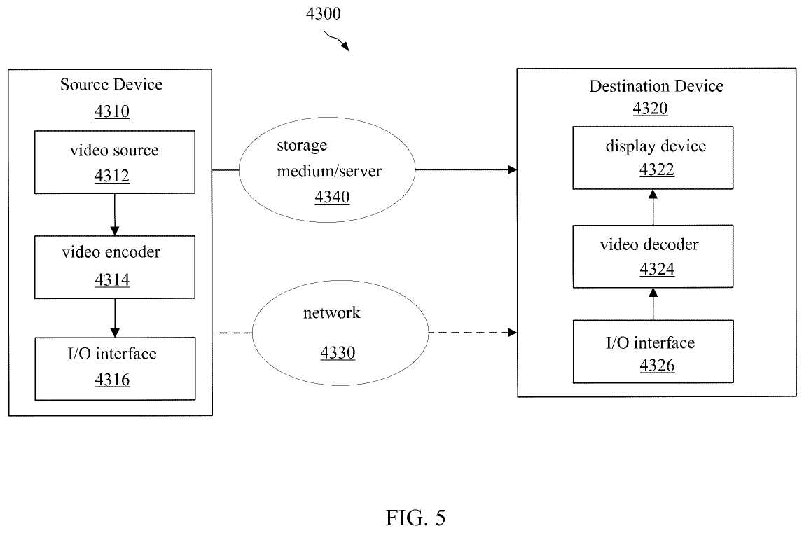

FIG. 5 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

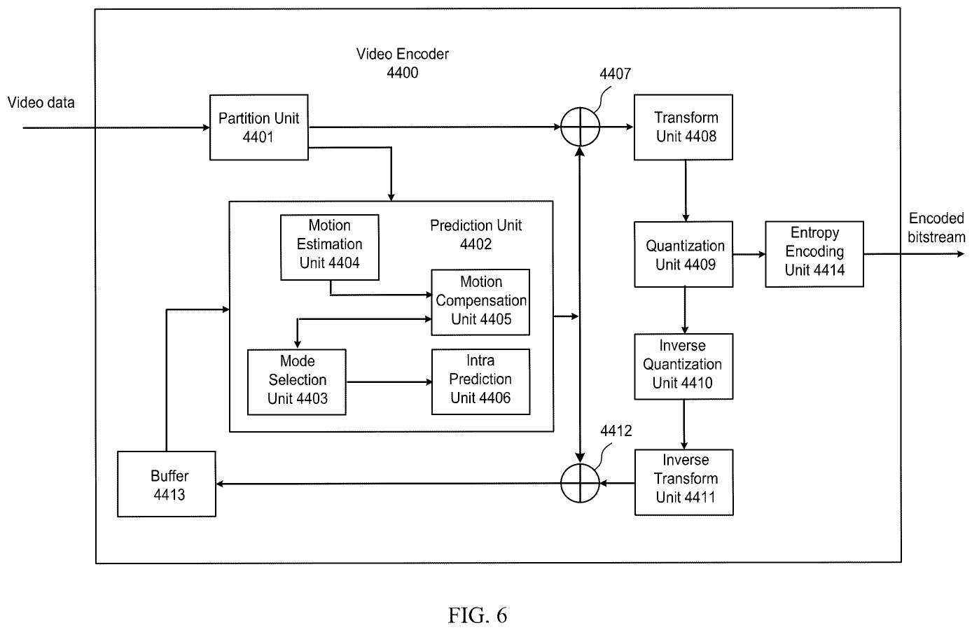

FIG. 6 is a block diagram illustrating an example of video encoder 4400, which may be video encoder 4314 in the system 4300 illustrated in FIG. 5. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

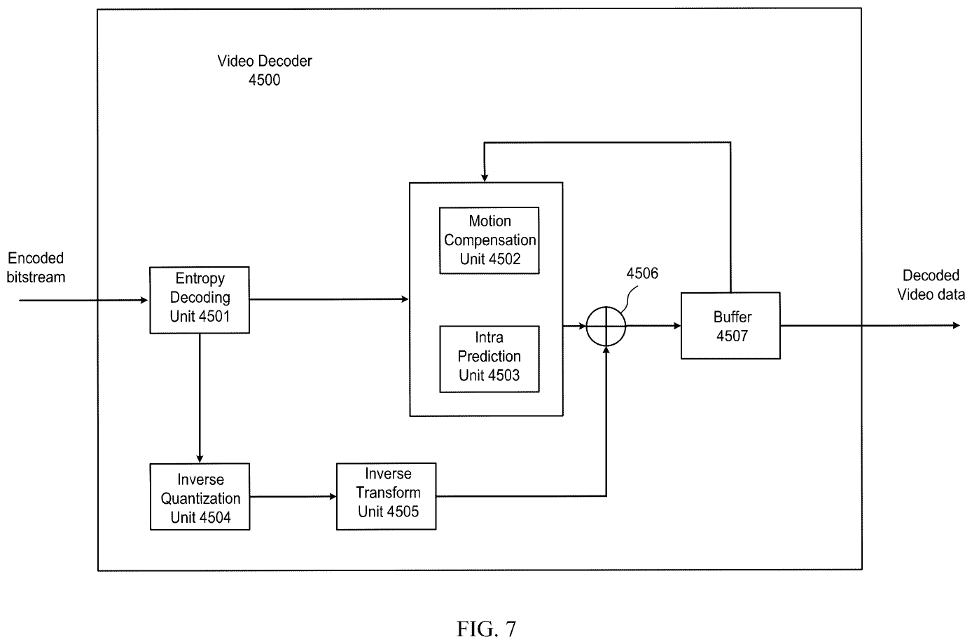

FIG. 7 is a block diagram illustrating an example of video decoder 4500 which may be video decoder 4324 in the system 4300 illustrated in FIG. 5. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

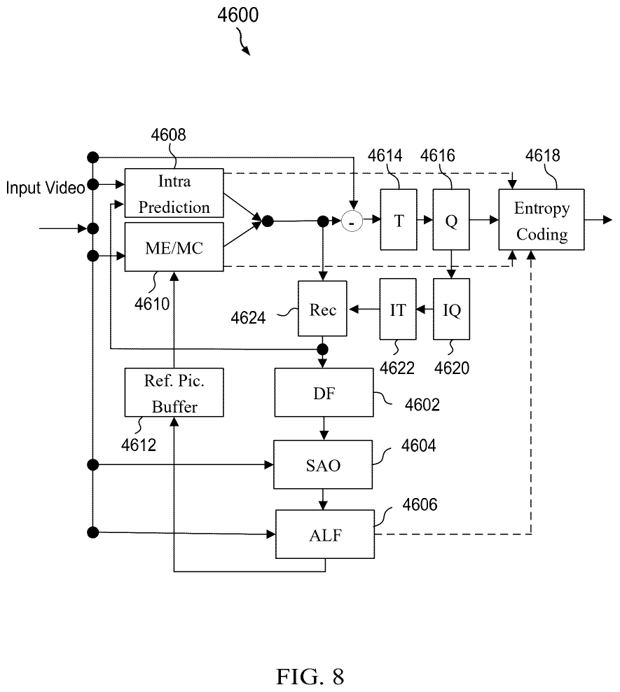

FIG. 8 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.
1. A method for processing media data comprising: determining to apply a metadata extension mechanism to a neural-network post-filter (NNPF) when neural-network post-filter characteristics (NNPFC) mode identification code (nnpfc_mode_idc) is equal to zero and to not apply the metadata extension mechanism when nnpfc_mode_idc is not equal to zero, the metadata extension mechanism including syntax elements NNPF metadata extension number of bits (nnpfc_metadata_extension_num bits) and NNPFC reserved metadata extension (nnpfc_reserved_metadata_extension); and performing a conversion between a visual media data and a bitstream based on the NNPF.
2. The method of solution 1, wherein signalling of the syntax element nnpfc_metadata_extension_num_bits is skipped when nnpfc_mode_idc is not equal to zero.
3. The method of any of solutions 1-2, wherein when nnpfc_metadata_extension_num_bits is not present, a value of nnpfc_metadata_extension_num_bits is inferred to be equal to 0.
4. The method of any of solutions 1-3, wherein when an NNPFC supplemental enhancement information (SEI) message nnpfcB is not the first NNPFC SEI message, in decoding order, that has a NNPFC identification (nnpfc_id) value within a current coded layer video sequence (CLVS), which contains nnpfcB, and a value of NNPFC base flag (nnpfc_base_flag) is equal to one, the NNPFC SEI message shall be a repetition of a first NNPFC SEI message nnpfcA with a same nnpfc_id value, in decoding order, within the current CLVS.
5. The method of any of solutions 1-4, wherein a payload content of nnpfcB shall be the same as that of nnpfcA.
6. The method of any of solutions 1-5, wherein a current CLVS is a CLVS containing a NNPFC SEI message nnpfcB, and a first NNPFC SEI message nnpfcA is within the current CLVS.
7. The method of any of solutions 1-6, wherein NNPFC abset input picture zero flag (nnpfc_absent_input_pic_zero_flag) equal to zero indicates that the NNPF expects an input picture inputPicA that is not present in the bitstream to be represented by an input picture that is closest to inputPicA in output order among all pictures within the bitstream that follow inputPicA in output order.
8. The method of any of solutions 1-7, wherein nnpfc_absent_input_pic_zero_flag equal to zero indicates that the NNPF expects an input picture inputPicA that is not present in the bitstream to be represented by an input picture that is closest to inputPicA in output order among all pictures within the bitstream that precede inputPicA in output order.
9. The method of any of solutions 1-8, wherein nnpfc_absent_input_pic_zero_flag equal to zero indicates that the NNPF expects an input picture inputPicA that is not present in the bitstream to be represented by an input picture inputPicB.
10. The method of any of solutions 1-9, wherein when inputPicA precedes, in output order, a first picture within the bitstream in output order, inputPicB is a picture that is the closest to inputPicA in output order among all pictures in the bitstream that follow inputPicA in output order.
11. The method of any of solutions 1-10, wherein when inputPicA follows, in output order, a last picture within the bitstream in output order, inputPicB is a picture that is closest to inputPicA in output order among all pictures in the bitstream that precede inputPicA in output order.
12. An apparatus for processing video data comprising: a processor; and a non-transitory memory with instructions thereon, wherein the instructions upon execution by the processor, cause the processor to perform the method of any of solutions 1-11.
13. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-11.
14. A non-transitory computer-readable recording medium storing a bitstream of a video which is generated by a method performed by a video processing apparatus, wherein the method comprises: determining to apply a metadata extension mechanism to a neural-network post-filter (NNPF) when neural-network post-filter characteristics (NNPFC) mode identification code (nnpfc_mode_idc) is equal to zero and to not apply the metadata extension mechanism when nnpfc_mode_idc is not equal to zero, the metadata extension mechanism including syntax elements NNPF metadata extension number of bits (nnpfc_metadata_extension_num_bits) and NNPFC reserved metadata extension (nnpfc_reserved_metadata_extension); and generating a bitstream based on the determining.
15. A method for storing bitstream of a video comprising: determining to apply a metadata extension mechanism to a neural-network post-filter (NNPF) when neural-network post-filter characteristics (NNPFC) mode identification code (nnpfc_mode_idc) is equal to zero and to not apply the metadata extension mechanism when nnpfc_mode_idc is not equal to zero, the metadata extension mechanism including syntax elements NNPF metadata extension number of bits (nnpfc_metadata_extension_num_bits) and NNPFC reserved metadata extension (nnpfc_reserved_metadata_extension); generating a bitstream based on the determining; and storing the bitstream in a non-transitory computer-readable recording medium.
16. A method, apparatus, or system described in the present disclosure.

The following solutions show further examples of techniques discussed herein.
1. A method for processing media data, comprising: determining that a value of a neural-network post-filter characteristics (NNPFC) input format indicator (nnpfc_inp_format_mc) is coded as a u(N) coded syntax element where N is an integer greater than 0; and performing a conversion between a visual media data and a bitstream based on the NNPFC input format indicator.
2. The method of solution 1, wherein NNPFC output format indicator (nnpfc_out_format_idc) is coded as a u(N) coded syntax element where N is an integer greater than 0.
3. The method of any of solutions 1-2, wherein NNPFC mode indicator (nnpfc_mode_idc) is coded as a u(N) coded syntax element where N is an integer greater than 0.
4. The method of any of solutions 1-3, wherein NNPFC input order indicator (nnpfc_inp_order_idc) is coded as a u(N) coded syntax element where N is an integer greater than 0.
5. The method of any of solutions 1-4, wherein NNPFC output order indicator (nnpfc_out_order_idc) is coded as a u(N) coded syntax element where N is an integer greater than 0.
6. The method of any of solutions 1-5, wherein NNPFC auxiliary input indicator (nnpfc_auxiliary_inp_idc) is coded as a u(N) coded syntax element where N is an integer greater than 0.
7. The method of any of solutions 1-6, wherein N is a value equal to 2, 3, or 4.
8. The method of any of solutions 1-7, wherein nnpfc_inp_format_idc and nnpfc_out_format_idc are coded as u(3)-coded syntax elements, and wherein nnpfc_mode_idc, nnpfc_inp_order_idc, nnpfc_out_order_idc, and nnpfc_auxiliary_inp_idc are coded as u(4)-coded syntax elements.
9. The method of any of solutions 1-8, wherein nnpfc_mode_idc is coded as a u(N)-coded syntax element, and wherein a value of nnpfc_mode_idc is constrained in a range of 0 to 2^{N}−1, inclusive.
10. The method of any of solutions 1-9, wherein nnpfc_inp_format_idc is coded as a u(N)-coded syntax element, and wherein a value of nnpfc_inp_format_idc is constrained in the range of 0 to 2^{N}−1, inclusive.
11. The method of any of solutions 1-10, wherein nnpfc_inp_order_idc is coded as a u(N)-coded syntax element, and wherein a value of nnpfc_inp_order_idc is constrained in the range of 0 to 2^{N}−1, inclusive.
12. The method of any of solutions 1-11, wherein nnpfc_auxiliary_inp_idc is coded as a u(N)-coded syntax element, and wherein a value of nnpfc_auxiliary_inp_idc is constrained in the range of 0 to 2^{N}−1, inclusive.
13. The method of any of solutions 1-12, wherein nnpfc_out_format_idc is coded as a u(N)-coded syntax element, and wherein a value of nnpfc_out_format_idc is constrained in the range of 0 to 2^{N}−1, inclusive.
14. The method of any of solutions 1-13, wherein nnpfc_out_order_idc is coded as a u(N)-coded syntax element, and wherein a value of nnpfc_out_order_idc is constrained in the range of 0 to 2^{N}−1, inclusive.
15. The method of any of solutions 1-14, wherein nnpfc_inp_format_idc indicates a mechanism of converting a sample value of the input picture to an input value to the neural-network post-filter (NNPF).
16. The method of any of solutions 1-15, wherein nnpfc_inp_order_idc indicates a mechanism of ordering the sample arrays of an input picture to form an input tensor to the NNPF.
17. The method of any of solutions 1-16, wherein nnpfc_out_order_idc indicates an output order of samples resulting from the NNPF.
18. The method of any of solutions 1-17, wherein nnpfc_out_format_idc indicates whether sample values output by the NNPF are real numbers or unsigned integer numbers.
19. The method of any of solutions 1-18, wherein nnpfc_mode_idc indicates whether a supplemental enhancement information (SEI) message specifies a base NNPF or an update to a base NNPF.
20. The method of any of solutions 1-19, wherein nnpfc_auxiliary_inp_idc indicates whether auxiliary input data is present in an input tensor of the NNPF.
21. The method of any of solutions 1-20, wherein the conversion includes encoding the visual media data into a bitstream.
22. The method of any of solutions 1-20, wherein the conversion includes decoding the visual media data from a bitstream.
23. An apparatus for processing video data comprising: a processor; and a non-transitory memory with instructions thereon, wherein the instructions upon execution by the processor, cause the processor to perform the method of any of solutions 1-22.
24. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-22.
25. A non-transitory computer-readable recording medium storing a bitstream of a video which is generated by a method performed by a video processing apparatus, wherein the method comprises: determining that a value of a neural-network post-filter characteristics (NNPFC) input format indicator (nnpfc_inp_format_inc) is coded as a u(N) coded syntax element where N is an integer greater than 0; and generating the bitstream based on the NNPFC input format indicator.
26. A method for storing bitstream of a video, comprising: determining that a value of a neural-network post-filter characteristics (NNPFC) input format indicator (nnpfc_inp_format_inc) is coded as a u(N) coded syntax element where N is an integer greater than 0; generating the bitstream based on the NNPFC input format indicator; and storing the bitstream in a non-transitory computer-readable recording medium.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including+10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
determining that at least one indicator syntax element for neural-network post-filter (NNPF) characteristics (NNPFC) is coded as a u(N)-coded syntax element where N is an integer greater than 0; and
performing a conversion between a visual media data and a bitstream based on the at least one indicator syntax element.

2. The method of claim 1, wherein the at least one indicator syntax element comprises a first syntax element, wherein the first syntax element indicates a method of converting a sample value of an input picture to an input value to an NNPF.

3. The method of claim 1, wherein the at least one indicator syntax element comprises a second syntax element,
wherein the second syntax element equal to 0 indicates that sample values output by the NNPF are real numbers where a value range of 0 to 1, inclusive, maps linearly to an unsigned integer value range of 0 to (1 «bitDepth)−1, inclusive, wherein bitDepth represents a desired bit depth for subsequent post-processing or displaying, and
wherein the second syntax element equal to 1 indicates that luma sample values output by the NNPF are unsigned integer numbers in a range of 0 to (1 «outTensorBitDepthy)−1, inclusive, and chroma sample values output by the NNPF are unsigned integer numbers in a range of 0 to (1 «outTensorBitDepthc)−1, inclusive, wherein outTensorBitDepthy specifies a bit depth of luma sample values in an output integer tensor and outTensorBitDepthc specifies a bit depth of chroma sample values in the output integer tensor.

4. The method of claim 1, wherein the at least one indicator syntax element comprises a third syntax element, and
wherein the third syntax element equal to 0 indicates that neural network information is contained in an NNPFC supplemental enhancement information (SEI) message, and the neural network information is in a format of an ISO/IEC 15938-17 bitstream, and
wherein the third syntax element equal to 1 indicates that neural network information is identified by a uniform resource identifier (URI) indicated by nnpfc_uri with a format identified by a tag URI nnpfc_tag_uri.

5. The method of claim 1, wherein the at least one indicator syntax element comprises a fourth syntax element, and
wherein the fourth syntax element indicates a method of ordering sample arrays of an input picture to form an input tensor to an NNPF.

6. The method of claim 1, wherein the at least one indicator syntax element comprises a fifth syntax element, and
wherein the fifth syntax element indicates an output order of samples resulting from an NNPF.

7. The method of claim 1, wherein the at least one indicator syntax element comprises a sixth syntax element,
wherein the sixth syntax element greater than 0 indicates that auxiliary input data is present in an input tensor of an NNPF, and
wherein the sixth syntax element equal to 0 indicates that auxiliary input data is not present in the input tensor of the NNPF.

8. The method of claim 1, wherein N is a value equal to 2, 3, or 4.

9. The method of claim 1, wherein a value of the at least one indicator syntax element is constrained in a range of 0 to 2^{N}−1, inclusive.

10. The method of claim 2, wherein the first syntax element is indicated as nnpfc_inp_format_idc and is coded as a u(3)-coded syntax element.

11. The method of claim 3, wherein the second syntax element is indicated as nnpfc_out_format_idc and is coded as a u(3)-coded syntax element.

12. The method of claim 4, wherein the third syntax element is indicated as nnpfc_mode_idc and is coded as a u(4)-coded syntax element.

13. The method of claim 5, wherein the fourth syntax element is indicated as nnpfc_inp_order_idc and is coded as a u(4)-coded syntax element.

14. The method of claim 6, wherein the fifth syntax element is indicated as nnpfc_out_order_idc and is coded as a u(4)-coded syntax element.

15. The method of claim 7, wherein the sixth syntax element is indicated as nnpfc_auxiliary_inp_idc and is coded as a u(4)-coded syntax element.

16. The method of claim 1, wherein the conversion includes encoding the visual media data into the bitstream.

17. The method of claim 1, wherein the conversion includes decoding the visual media data from the bitstream.

18. An apparatus for processing video data comprising: a processor; and a non-transitory memory with instructions thereon, wherein the instructions upon execution by the processor, cause the processor to:
determine that at least one indicator syntax element for neural-network post-filter (NNPF) characteristics (NNPFC) is coded as a u(N)-coded syntax element where N is an integer greater than 0; and
perform a conversion between a visual media data and a bitstream based on the at least one indicator syntax element.

19. The apparatus of claim 18, wherein the at least one indicator syntax element comprises a first syntax element, wherein the first syntax element indicates a method of converting a sample value of an input picture to an input value to an NNPF.

20. A non-transitory computer-readable recording medium storing a bitstream of a video which is generated by a method performed by a video processing apparatus, wherein the method comprises:
determining that at least one indicator syntax element for neural-network post-filter (NNPF) characteristics (NNPFC) is coded as a u(N)-coded syntax element where N is an integer greater than 0; and
generating the bitstream based on the at least one indicator syntax element.
